(19) United States
(12) Patent Application Publication
(10) Pub. No.: US 2009/0296027 A1
(43) Pub. Date: Dec. 3, 2009

(54) ELLIPTICALLY POLARIZING PLATE AND IMAGE DISPLAY DEVICE USING THE SAME

(75) Inventors: Ikuo Kawamoto, Osaka (JP); Seiji Umemoto, Osaka (JP); Hideyuki Yonezawa, Osaka (JP); Kazuya Hada, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/300,583

(22) PCT Filed: Apr. 23, 2007
(86) PCT No.: PCT/JP2007/058704

§ 371 Date: Feb. 24, 2009

(30) Foreign Application Priority Data
May 12, 2006 (JP) 2006-133544
Jul. 14, 2006 (JP) 2006-194039

(51) Int. Cl. G02F 1/1335

(52) U.S. Cl. 349/96

(57) ABSTRACT

Provided are an elliptically polarizing plate that is excellent in contrast in an oblique direction and has a broadband and a wide viewing angle, and an image display device using the elliptically polarizing plate. The elliptically polarizing plate of the present invention includes in order: a polarizer; a protective layer; a first birefringent layer having a refractive index profile of nz>nx=ny; a second birefringent layer that functions as a λ/2 plate; and a third birefringent layer that functions as a λ/4 plate. A ratio Rth₁/Rthp between an absolute value Rthp of a thickness direction retardation of the protective layer and an absolute value Rth₁ of a thickness direction retardation of the first birefringent layer is preferably in a range of 1.1 to 4.

### TECHNICAL FIELD

The present invention relates to an elliptically polarizing plate, and to an image display device using the elliptically polarizing plate. More specifically, the present invention relates to an elliptically polarizing plate being excellent in contrast in an oblique direction and having a broadband and a wide viewing angle, and to an image display device using the elliptically polarizing plate.

### BACKGROUND ART

Various optical films each having a polarizing film and a retardation plate in combination are generally used for various image display devices such as a liquid crystal display device and an electroluminescence (EL) display, to thereby obtain optical compensation.

In general, a circularly polarizing plate which is one type of the optical films can be produced by combining a polarizing film and λ/4 plate. However, the λ/4 plate has properties providing larger retardation values with shorter wavelengths, so-called “positive wavelength dispersion properties”, and the λ/4 plate generally has high positive wavelength dispersion properties. Thus, the λ/4 plate has a problem in that the λ/4 plate cannot exhibit desired optical properties (such as functions of the λ/4 plate) over a wide wavelength range. In order to avoid the problem, there has been recently proposed a retardation plate having wavelength dispersion properties providing larger retardation values with longer wavelengths, so-called “reverse dispersion properties” such as a modified cellulose-based film or a modified polycarbonate-based film. However, such a film has problems in cost.

At present, λ/4 plate having positive wavelength dispersion properties is combined with, for example, a retardation plate providing larger retardation values with longer wavelengths or a λ/2 plate, to thereby correct the wavelength dispersion properties of the λ/4 plate (see Patent Document 1, for example).

In the case where the polarizing film, the λ/4 plate, and the λ/2 plate are combined as described above, angles of respective optical axes, that is, angles between an absorption axis of the polarizing film and slow axes of the respective retardation plates must be adjusted. However, the optical axes of the polarizing film and the retardation plates each formed of a stretched film generally vary depending on stretching directions. The respective films must be cut out in accordance with directions of the respective optical axes and laminated, to thereby laminate the films such that the absorption axis and the slow axes are at desired angles. To be specific, an absorption axis of a polarizing film is generally in parallel with its stretching direction, and a slow axis of a retardation plate is also in parallel with its stretching direction. Thus, for lamination of the polarizing film and the retardation plate at an angle between the absorption axis and the slow axis of 45°, for example, one of the films must be cut out in a direction of 45° with respect to a longitudinal direction (stretching direction) of the film. In the case where the film is cut out and then attached as described above, angles between optical axes may vary by cut-out film, for example. The variation may result in the problems of variation in quality by product and production requiring high cost and long time. Further problems include increased waste by cutting out of the films, and difficulties in production of large films.

As a countermeasure to the problems, there is proposed a method of adjusting a stretching direction by stretching a polarizing film or a retardation plate in an oblique direction or the like (see Patent Document 2, for example). However, the method has a problem in that the adjustment involves difficulties.

Further, along with the increase in definition of an image display device, there is also a demand for further improvement of the properties of an elliptically polarizing plate in an oblique direction and the properties thereof such as a viewing angle.

### Patent Document 1: JP 3174367 B

### Patent Document 2: JP 2003-195037 A

### DISCLOSURE OF THE INVENTION

### Problems to be Solved by the Invention

The present invention has been made in view of solving the above-mentioned problems, and objects of the present invention is to provide an elliptically polarizing plate being excellent in contrast in an oblique direction and having a broadband and a wide viewing angle, and an image display device using the elliptically polarizing plate.

### Means for Solving the Problems

The inventors of the present invention have earnestly studied the properties of the elliptically polarizing plate, and as a result, have found that the above-mentioned objects can be achieved by further laminating a birefringent layer having particular optical properties in a particular positional relationship in addition to λ/4 plate and λ/2 plate, thereby completing the present invention.

An elliptically polarizing plate of the present invention, including, in a stated order: a polarizer; a protective layer; a first birefringent layer having a refractive index profile of nz>nx=ny; a second birefringent layer that functions as a λ/2 plate; and a third birefringent layer that functions as λ/4 plate.

According to a preferred embodiment, in the above-mentioned elliptically polarizing plate, a ratio Rth₁/Rthp between an absolute value Rthp of a thickness direction retardation of the protective layer and an absolute value Rth₁ of a thickness direction retardation of the first birefringent layer is in a range of 1.1 to 4.

According to a preferred embodiment, in the above-mentioned elliptically polarizing plate, an absorption axis of the polarizer and a slow axis of the third birefringent layer are substantially perpendicular to each other.

According to a preferred embodiment, a slow axis of the second birefringent layer defines an angle of +8° to +38° or −8° to −38° with respect to the absorption axis of the polarizer.

According to a preferred embodiment, the above-mentioned protective layer is formed of a film containing triacetyl cellulose as a main component.

According to another aspect of the present invention, an image display device is provided. The image display device includes the elliptically polarizing plate. In a preferred embodiment, the elliptically polarizing plate is placed on a viewer side.

### Effects of the Invention

As described above, according to the present invention, the polarizer, the protective layer, the first birefringent layer having a refractive index profile of nz>nx=ny, the second birefringent layer that functions as the λ/2 plate, and the third birefringent layer that functions as the λ/4 plate are provided in order, whereby the elliptically polarizing plate that is excellent in contrast in an oblique direction and has a broadband and a wide viewing angle, and the image display device using the elliptically polarizing plate can be obtained. Preferably, the first birefringent layer having a refractive index profile of nz>nx=ny is placed adjacent to the protective layer of the polarizing plate, and the λ/2 plate (second birefringent layer) having a refractive index profile of nx>ny=nz and the λ/4 plate (third birefringent layer) having a refractive index profile of nx>ny>nz are placed in order from the first birefringent layer side, whereby excellent contrast in an oblique direction can be realized, in which the angle at which contrast 20 or more is obtained is 80° at maximum. Such an effect is not clarified theoretically, and is a finding that has been obtained only after the elliptically polarizing plate and the image display device using the elliptically polarizing plate were produced actually. Thus, the effect is an expected excellent effect. It can be inferred that light (i.e., polarized light) passing through the polarizer enters the first birefringent layer (so-called positive C plate) directly from the protective layer, whereby the shift of a polarization state caused by the retardation of the protective layer is compensated very satisfactorily in the first birefringent layer, and consequently, the decrease in contrast not only in a front direction but also in an oblique direction is suppressed. Further, the above-mentioned effect becomes conspicuous in the case where a ratio Rth₁/Rthp between an absolute value Rthp of a thickness direction retardation of the protective layer and an absolute value Rth₁ of a thickness direction retardation of the first birefringent layer is in the range of 1.1 to 4.

### BRIEF DESCRIPTION OF THE DRAWINGS

FIG. 1 is a schematic cross-sectional view of an elliptically polarizing plate according to a preferred embodiment of the present invention.

FIG. 2 is an exploded perspective view of the elliptically polarizing plate according to the preferred embodiment of the present invention.

FIG. 3 is a perspective view schematically showing one step in one example of a method of producing the elliptically polarizing plate of the present invention.

FIG. 4 is a perspective view schematically showing another step in one example of the method of producing the elliptically polarizing plate of the present invention.

FIG. 5 is a view schematically showing still another step in one example of the method of producing the elliptically polarizing plate of the present invention.

FIG. 6 is a view schematically showing still another step in one example of the method of producing the elliptically polarizing plate of the present invention.

FIG. 7 is a view schematically showing still another step in one example of the method of producing the elliptically polarizing plate of the present invention.

FIG. 8 is a schematic cross-sectional view of a liquid crystal panel used in a liquid crystal display device according to the preferred embodiment of the present invention.

FIG. 9 is a contrast contour drawing of a liquid crystal display device using an elliptically polarizing plate of an example according to the present invention.

FIG. 10 is a contrast contour drawing of a liquid crystal display device using an elliptically polarizing plate of a comparative example.

FIG. 11 is a contrast contour drawing of a liquid crystal display device using an elliptically polarizing plate of another comparative example.

FIG. 12 is a contrast contour drawing of a liquid crystal display device using an elliptically polarizing plate of still another comparative example.

FIG. 13 is a perspective view schematically showing a configuration of a rubbing treatment apparatus.

FIG. 14(a) is a front view showing the vicinity of a rubbing roll, and FIG. 14(b) is a front view showing the vicinity of a contact portion between the rubbing roll and a long base film surface in an enlarged state.

### DESCRIPTION OF SYMBOLS

1, 2 Driving roll
3 Conveying belt
4 Rubbing roll
4a raised fabric
5 Back-up roll
F Continuous substrate film
10 Elliptically polarizing plate
11 Polarizer
12 Protective layer
13 First birefringent layer
14 Second birefringent layer
15 Third birefringent layer
20 Liquid crystal cell
100 Liquid crystal panel

### BEST MODE FOR CARRYING OUT THE INVENTION

### A. Elliptically Polarizing Plate

### A-1. Entire Configuration of Elliptically Polarizing Plate

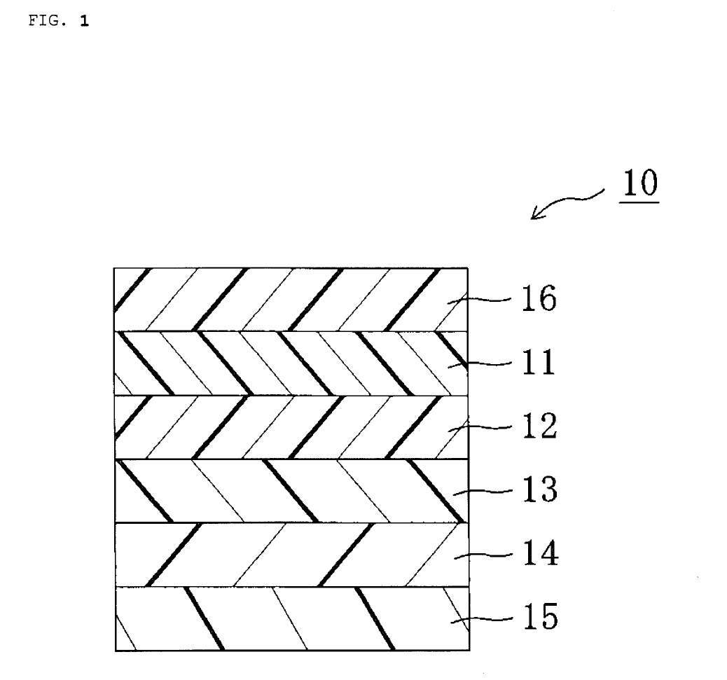

An elliptically polarizing plate of the present invention includes a polarizer, a protective layer, a first birefringent layer having a refractive index profile of nz>nx=ny, a second birefringent layer that functions as λ/2 plate, and a third birefringent layer that functions as a λ/4 plate in order. For example, as shown in FIG. 1, an elliptically polarizing plate 10 includes a polarizer 11, a protective layer 12, a first birefringent layer 13, a second birefringent layer 14, and a third birefringent layer 15. According to such a configuration, the optical axis shift of each layer when viewed obliquely and the shift of a polarization state caused by a retardation of the protective layer can be compensated satisfactorily, and hence the function as a polarizing plate at a wide viewing angle can be ensured. Further, the retardation of the protective layer is offset by the first birefringent layer, whereby the linear polarization property of polarizing plate output light is recovered, and the function as the polarizing plate at a wide viewing angle can be ensured. Practically, the elliptically polarizing plate of the present invention can have a second protective layer 16 on a side of the polarizer where the protective layer 12 is not laminated.

The first birefringent layer 13 has a refractive index profile of nz>nx=ny, and can function as a so-called positive C plate. The second birefringent layer 14 functions as a so-called λ/2 plate. Herein, the λ/2 plate refers to a plate that has a function of converting linearly polarized light having a particular oscillation direction into linearly polarized light having an oscillation direction perpendicular to the oscillation direction of the linearly polarized light having the particular oscillation direction or converting right-handed circularly polarized light into left-handed circularly polarized light (or left-handed circularly polarized light into right-handed circularly polarized light). The third birefringent layer 15 functions as a so-called λ/4 plate. Herein, the λ/4 plate refers to a plate that has a function of converting linearly polarized light having a particular wavelength into circularly polarized light (or circularly polarized light into linearly polarized light). Further, a ratio Rth₁/Rthp between an absolute value Rthp of a thickness direction retardation of the protective layer 12 and an absolute value Rth₁ of a thickness direction retardation of the first birefringent layer 13 is preferably in the range of 1.1 to 4.0, and more preferably in the range of 1.5 to 3.0. The thickness direction retardation of the protective layer 12 and the first birefringent layer 13 has such a relationship, whereby the retardation of the protective layer can be compensated satisfactorily, and as a result, an elliptically polarizing plate having excellent properties in an oblique direction can be obtained. Herein, nx denotes a refractive index in a direction in which an in-plane refractive index becomes maximum (i.e., a slow axis direction), ny denotes a refractive index in a direction perpendicular to the slow axis in a plane, and nz denotes a refractive index in a thickness direction. The thickness direction retardation Rth refers to a thickness direction retardation measured with light having a wavelength of 590 nm at 23° C. The thickness direction retardation Rth is obtained by the expression: Rth=(nx−nz)×d, where d (nm) is a thickness of a film (layer). nx and nz are as described above. Rth is generally measured at a wavelength of 590 nm. Further, “nx=ny” includes not only the case where nx and ny are exactly equal to each other, but also the case where nx and ny are substantially equal to each other. Herein, “substantially equal” also includes the case where nx and ny are different in such a range as not to have a practical influence on the entire polarization properties of the elliptically polarizing plate.

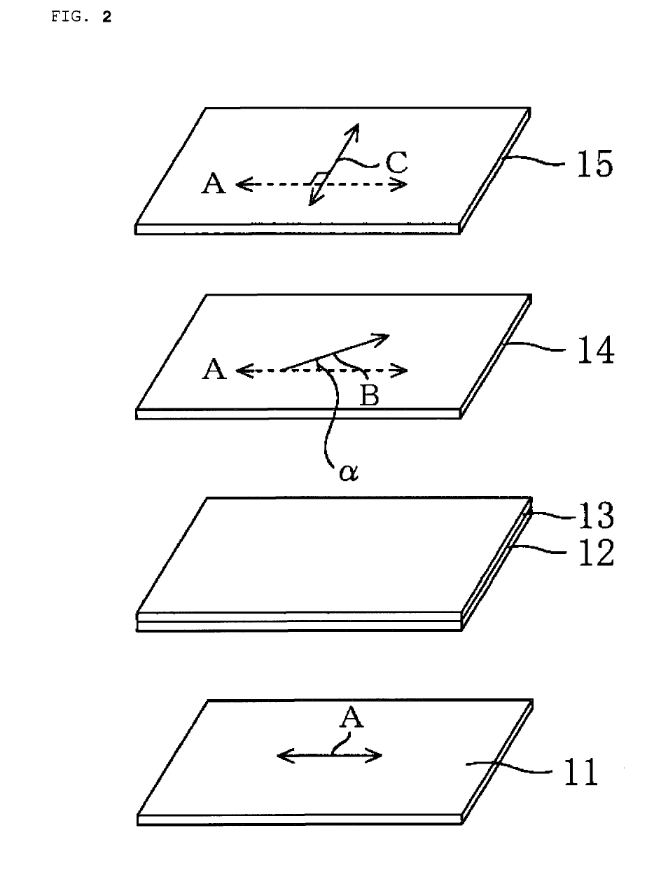

FIG. 2 is an exploded perspective view explaining optical axes of respective layers forming the elliptically polarizing plate according to a preferred embodiment of the present invention (In FIG. 2, the second protective layer 16 is omitted for an easy view) The second birefringent layer 14 is laminated such that its slow axis B is defined at a predetermined angle α with respect to an absorption axis A of the polarizer 11. The angle α is preferably +8° to +38° or −8° to −38°, more preferably +130 to +330 or −130 to −33°, particularly preferably +19° to +29° or −19° to −29°, especially preferably +21° to +27° or −21° to −27°, and most preferably +23° to +24° or −23° to −24°. The second birefringent layer and the polarizer are laminated at such an angle α as described above, to thereby provide a polarizing plate with excellent circularly polarization properties. As shown in FIG. 2, the third birefringent layer 15 is laminated such that its slow axis C is substantially perpendicular to the absorption axis A of the polarizer 11. Herein, the phrase “substantially perpendicular” includes a case at an angle of 90°±2.0°, preferably 90°±1.0°, and more preferably 90°±0.5°.

The total thickness of the elliptically polarizing plate of the present invention is preferably 80 to 250 μm, more preferably 110 to 220 μm, and most preferably 140 to 190 μm. According to a method of producing the elliptically polarizing plate of the present invention (described later), the first birefringent layer (and the second birefringent layer in some cases) can be laminated without using an adhesive, and hence the total thickness can be reduced to about ¼ at minimum compared with that of a conventional elliptically polarizing plate. As a result, the elliptically polarizing plate of the present invention can greatly contribute to the reduction in thickness of an image display device. Hereinafter, the detail of each layer constituting the elliptically polarizing plate of the present invention will be described.

### A-2. First Birefringent Layer

As described above, the first birefringent layer 13 has a refractive index profile of nz>nx=ny, and can function as a so-called positive C plate. Further, as described above, the absolute value Rth₁ of a thickness retardation of the first birefringent layer has a particular proportion with respect to the absolute value Rth₁ of a thickness direction retardation of the protective layer. By providing the first birefringent layer having such optical properties, the thickness direction retardation of the protective layer can be compensated satisfactorily. As a result, an elliptically polarizing plate having excellent properties even in an oblique direction can be obtained.

As described above, the absolute value Rth₁ of a thickness direction retardation of the first birefringent layer can be optimized depending upon the absolute value Rthp of a thickness direction retardation of the protective layer. For example, the absolute value Rth₁ of a thickness direction retardation of the first birefringent layer is preferably 50 to 200 nm, more preferably 75 to 150 nm, and most preferably 90 to 120 nm. The thickness of the first birefringent layer in which such an absolute value is obtained can varies depending upon a material to be used and the like. For example, the thickness of the first birefringent layer is preferably 0.5 to 10 μm, more preferably 0.5 to 8 μm, and most preferably 0.5 to 5 μm.

The first birefringent layer is preferably made of a film containing a liquid crystal material immobilized in homeotropic alignment. A liquid crystal material (liquid crystal compound) that can be aligned homeotropically may be a liquid crystal monomer or a liquid crystal polymer. A typical example of the liquid crystal compound includes a nematic liquid crystal compound. The summary regarding the alignment technique of such a liquid crystal compound is described in, for example, Chemical Introduction 44 (Surface Reforming, edited by The Chemical Society of Japan, pages 156-163).

Further, an example of the liquid crystal material in which homeotropic alignment can be formed includes a side-chain type liquid crystal polymer containing a monomer unit (a) containing a liquid-crystalline fragment side chain and a monomer unit (b) containing an non-liquid crystalline fragment side chain. Such a side-chain type liquid crystal polymer can realize homeotropic alignment using neither a homeotropic alignment agent nor a homeotropic alignment film. The side-chain type liquid crystal polymer has the monomer unit (b) containing an non-liquid crystalline fragment side chain having an alkyl chain or the like, in addition to the monomer unit (a) containing a liquid crystalline fragment side chain of a general side-chain type liquid crystal polymer. It can be inferred that, due to the function of the monomer unit (b) containing an non-liquid crystalline fragment side chain, a liquid crystal state (for example, a nematic liquid crystal phase) can be expressed by, for example, heat treatment, even without using a homeotropic alignment agent or a homeotropic alignment film.

The monomer unit (a) has a side chain having nematic liquid crystallinity, and an example thereof includes a monomer unit represented by General Formula (a).

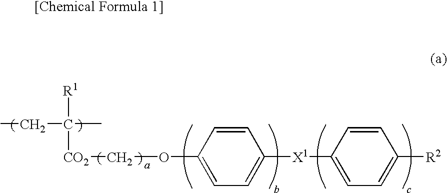

In General Formula (a), R¹ represents a hydrogen atom or a methyl group; a is a positive integer of 1 to 6; X¹ is a —CO₂— group or a —OCO— group; R² is a cyano group, an alkoxy group having 1 to carbon atoms, a fluoro group, or an alkyl group having 1 to 6 carbon atoms; and b and c respectively represent an integer of 1 to 2.

Further, the monomer unit (b) has a straight side-chain, and an example thereof includes a monomer unit represented by General Formula (b).

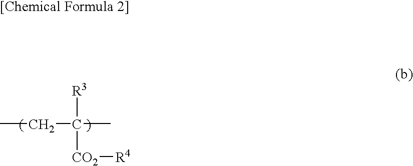

In General Formula (b), R³ represents a hydrogen atom or a methyl group; R⁴ represents an alkyl group having 1 to 22 carbon atoms, a fluoroalkyl group having 1 to 22 carbon atoms, or a group represented by General Formula (b1).

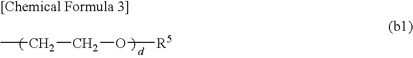

In General Formula (b1), d represents a positive integer of 1 to 6, and R⁵ represents an alkyl group having 1 to 6 carbon atoms.

Further, the ratio between the monomer unit (a) and the monomer unit (b) can be set appropriately depending upon the purpose and the kind of the monomer units. (b)/{(a)+(b)} is preferably 0.01 to 0.8 (molar ratio), and more preferably 0.1 to 0.5 (molar ratio). This is because, when the proportion of the monomer unit (b) increases, the side-chain type liquid crystal polymer may not exhibit a liquid crystal mono-domain alignment property in most cases.

Further, an example of the liquid crystal material in which the homeotropic alignment can be formed includes a side-chain type liquid crystal polymer containing the monomer unit (a) containing a liquid crystalline fragment side chain and a monomer unit (c) containing a liquid crystalline fragment side chain having an alicyclic ring structure. Such a side-chain type liquid crystal polymer can also realize homeotropic alignment without using a homeotropic alignment agent or a homeotropic alignment film. The side-chain type liquid crystal polymer has the monomer unit (c) containing a liquid crystalline fragment side chain having an alicyclic ring structure, in addition to the monomer unit (a) containing a liquid crystalline fragment side chain of a general side-chain type liquid crystal polymer. It can be inferred that, due to the function of the monomer unit (c), a liquid crystal state (for example, a nematic liquid crystal phase) can be expressed by, for example, heat treatment even without using a homeotropic alignment film, and homeotropic alignment can be realized.

The monomer unit (c) has a side chain having nematic liquid crystallinity, and an example thereof includes a monomer unit represented by General Formula (c).

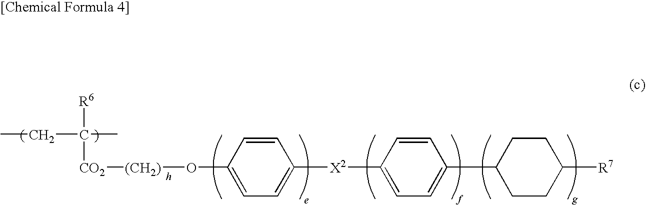

In General Formula (c), R⁶ represents a hydrogen atom or a methyl group; h represents a positive integer of 1 to 6; X² represents a —CO₂— group or a —OCO— group; e and g each represent an integer of 1 or 2; f represents an integer of 0 to 2; and R⁷ represents a cyano group or an alkyl group having 1 to 12 carbon atoms.

Further, the ratio between the monomer unit (a) and the monomer unit (c) can be set appropriately depending upon the purpose and the kind of the monomer units. (c)/{(a)+(c)} is preferably 0.01 to 0.8 (molar ratio), and more preferably 0.1 to 0.6 (molar ratio). This is because, when the proportion of the monomer unit (b) increases, the side-chain type liquid crystal polymer may not exhibit a liquid crystal mono-domain alignment property in most cases.

The above-mentioned monomer units are described merely for an illustrative purpose, and needless to say, the liquid crystal polymer in which the homeotropic alignment can be formed is not limited to the polymer having the above-mentioned monomer units. Further, the monomer units exemplified above can be combined appropriately.

The weight average molecular weight of the side-chain type liquid crystal polymer is preferably 2,000 to 100,000. By adjusting the weight average molecular weight in such a range, the performance as the liquid crystal polymer can be exhibited satisfactorily. The weight average molecular weight is more preferably 2,500 to 50,000. In such a range, the liquid crystal polymer is excellent in film forming property in the alignment layer, and a uniform alignment state can be formed.

The side-chain type liquid crystal polymer exemplified above can be prepared by copolymerizing the monomer unit (a), the monomer unit (b), or an acrylic monomer or a methacrylic monomer corresponding to the monomer unit (c). The monomer unit (a), the monomer unit (b), or the monomer corresponding to the monomer unit (c) can be synthesized by any suitable method. The copolymer can be prepared by any suitable polymerization method for an acrylic monomer or the like (for example, a radical polymerization method, a cation polymerization method, an anion polymerization method). In the case of using the radical polymerization method, various kinds of polymerization initiators can be used. Preferred examples of the polymerization initiator include azobisiobutylonitrile or benzoyl peroxide for the following reason. Since they can be decomposed at an appropriate temperature (not too high and not too low), the polymerization can be started through an appropriate mechanism at an appropriate speed.

The homeotropic alignment can also be formed from a liquid crystalline composition containing the side-chain type liquid crystal polymer. Such a liquid crystalline composition can contain a photopolymerizable liquid crystal compound in addition to the above-mentioned polymer. The photopolymerizable liquid crystal compound is a liquid crystal compound having at least one photopolymerizable functional group (for example, an unsaturated double-bond such as an acryloyl group or a methacryloyl group). It is preferred that the photopolymerizable liquid crystal compound exhibit nematic liquid crystallinity. Specific examples of the photopolymerizable liquid crystal compound include acrylate and methacrylate that can be also used as the monomer unit (a). A more preferred photopolymerizable liquid crystal compound has at least two photopolymerizable functional groups. This is because such a photopolymerizable compound can enhance the durability of a film (second birefringent layer) to be obtained. An example of such a photopolymerizable liquid crystal compound includes a cross-linking nematic liquid crystal monomer represented by the following Formula. Further, as the photopolymerizable liquid crystal compound, a compound obtained by substituting a vinyl ether group or an epoxy group for “H₂C═CR—CO₂—” at an end in the following Formula, and a compound obtained by substituting “—(CH₂)₃—C*H(CH₃)— (CH₂)₂—” or “—(CH₂)₂—C*H(CH₃)—(CH₂)₃—” for “—(CH₂)ₘ—” and/or “—(CH₂)ₙ—” can be exemplified.

[Chemical Formula 5]

H₂C═CR⁸—CO₂—(CH₂)ₘ—O-A-Y—B—Y—D—O—(CH₂)ₙ—O₂C—CR⁸═CH₂ (d)

In the above-mentioned Formula, R⁸ represents a hydrogen atom or a methyl group; A and D each independently represent a 1,4-phenylene group or a 1,4-cyclohexylene group; Y each independently represents a-COO-group, a OCO-group, or a-O-group; B represents a 1,4-phenylene group, a 1,4-cyclohexylene group, a 4,4′-biphenylene group, or a 4,4′-bicyclohexylene group; and m and n each independently represent an integer of 2 to 6.

The photopolymerizable liquid crystal compound is allowed to express, for example, a nematic liquid crystal phase as a liquid crystal state by heat treatment, and can be aligned homeotropically together with the side-chain type liquid crystal polymer. Then, the photopolymerizable liquid crystal compound is polymerized or cross-linked to immobilize the homeotropic alignment, whereby the durability of a homeotropically aligned liquid crystal film can be further enhanced.

The ratio between the photopolymerizable liquid crystal compound and the side-chain type liquid crystal polymer in the liquid crystalline composition can be set appropriately, in consideration of the purpose, the kinds of the side-chain type liquid crystal polymer and the photopolymerizable liquid crystal compound to be used, the durability of the homeotropically aligned liquid crystal film to be obtained, and the like. Specifically, the ratio between the photopolymerizable liquid crystal compound and the side-chain type liquid crystal polymer (weight ratio) is preferably about 0.1:1 to 30:1, more preferably 0.5:1 to 20:1, and most preferably 1:1 to 10:1.

The liquid crystalline composition can further contain a photopolymerization initiator. As the photopolymerization initiator, any suitable photopolymerization initiator can be adopted. Specifically, Irgacure 907, Irgacure 184, Irgacure 651, Irgacure 369, and the like manufactured by Ciba Specialty Chemicals Inc. can be exemplified. The content of the photopolymerization initiator can be adjusted to such a degree as not to disturb the homeotropic alignment property of the liquid crystalline composition, in consideration of the kind of the photopolymerizable liquid crystal compound, the compounding ratio of the liquid crystalline composition, and the like. Typically, the content of the photopolymerization initiator is preferably about 0.5 to 30 parts by weight, and more preferably 0.5 to 10 parts by weight with respect to 100 parts by weight of the photopolymerizable liquid crystal compound.

### A-3. Second Birefringent Layer

As described above, the second birefringent layer 14 functions as a so-called λ/2 plate. The second birefringent layer functions as λ/2 plate, whereby a retardation can be adjusted appropriately with respect to the wavelength dispersion properties (particularly, a wavelength range in which a retardation is out of λ/4) of the third birefringent layer that functions as a λ/4 plate. An in-plane retardation (Δnd) of the second birefringent layer is preferably 180 to 300 nm, more preferably 210 to 280 nm, and most preferably 230 to 240 nm at a wavelength of 590 nm. The in-plane retardation (Δnd) is obtained from the expression Δnd=(nx−ny)×d. Herein, nx and ny represent those described above, and d is a thickness of the second birefringent layer. Further, it is preferred that the second birefringent layer 14 have a refractive index profile of nx>ny=nz. Herein, “ny=nz” includes the case where ny and nz are substantially equal to each other, as well as the case where ny and nz are exactly equal to each other.

The thickness of the second birefringent layer may be set such that the layer serves as a λ/2 plate most appropriately. That is, the thickness thereof may be set so as to obtain a desired in-plane retardation. Specifically, the thickness of the second birefringent layer is preferably 0.5 to 5 μm, more preferably 1 to 4 μm, and most preferably 1.5 to 3 μm.

Any appropriate material may be employed as a material used for forming the second birefringent layer as long as the above-mentioned properties can be obtained. A liquid crystal material is preferred, and a liquid crystal material having a crystal phase of a nematic phase (nematic liquid crystal) is more preferred. Use of the liquid crystal material remarkably increases a difference between nx and ny of the birefringent layer to be obtained compared with the case of using a non-liquid crystal material. As a result, the thickness of the birefringent layer can be remarkably reduced for obtaining a desired in-plane retardation. Examples of the liquid crystal material that may be used include a liquid crystal polymer and a liquid crystal monomer. The liquid crystal material may exhibit liquid crystallinity through a lyotropic or thermotropic mechanism. Further, liquid crystals are preferably aligned in homogeneous alignment. The liquid crystal polymer and the liquid crystal monomer may each be used alone or may be used in combination.

A liquid crystalline monomer used as the liquid crystal material is preferably a polymerizable monomer and a cross-linking monomer, for example. As described below, this is because the alignment state of the liquid crystalline monomer can be fixed by polymerizing or cross-linking the liquid crystalline monomer. The alignment state of the liquid crystalline monomer can be fixed by aligning the liquid crystalline monomers and then polymerizing or cross-linking the liquid crystalline monomers with each other, for example. A polymer is formed through polymerization, and a three-dimensional network structure is formed through cross-linking. However, the polymer and the three-dimensional network structure are not liquid crystalline. Thus, the formed first birefringent layer will not undergo phase transition into a liquid crystal phase, a glass phase, or a crystal phase by change in temperature which is specific to a liquid crystalline compound. As a result, the first birefringent layer is formed to serve as a birefringent layer that has excellent stability and is not affected by change in temperature.

As the liquid crystal monomer, any suitable liquid crystal monomer can be adopted. For example, a polymerizable mesogenic compound, etc. described in JP2002-533742A (WO 00/37585), EP358,208 (U.S. Pat. No. 5,211,877), EP 66,137 (U.S. Pat. No. 4,388,453), WO 93/22397, EP 0,261,712, DE 19504224, DE 4408171, GB 2280445, and the like can be used. Specific examples of such a polymerizable mesogenic compound include LC242 (trade name) manufactured by BASF Corporation, E7 (trade name) manufactured by Merck Ltd., and LC-Sillicon-CC3767 (trade name) manufactured by Wacker-Chem GMBH.

As the liquid crystal monomer, for example, a nematic liquid crystal monomer is preferred, and specifically, there is mentioned a monomer represented by the following Formula (1). Those liquid crystal monomers can be used alone or in combination.

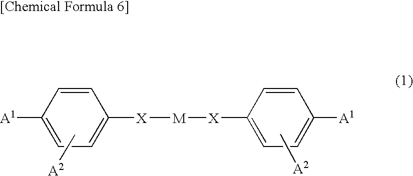

In the above-mentioned Formula (1): A¹ and A² each represent a polymerizable group, which may be the same as or different from each other; one of A¹ and A² may be hydrogen; X's each independently represent a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR; R represents H or C₁ to C₄ alkyl; and M represents a mesogenic group.

In the above-mentioned Formula (1), although X's may be the same as or different from each other, it is preferred that X's are the same as each other.

In the monomer of the above-mentioned Formula (1), it is preferred that each A² is placed at an ortho position with respect to A¹.

Further, the above-mentioned A¹ and A² are preferably each independently represented by the following Formula:

Z-X-(Sp)ₙ (2)

it is preferred that A¹ and A² be the same group.

In the above-mentioned Formula (2): Z represents a cross-linking group; X is as defined by the above-mentioned Formula (1); Sp represents a spacer formed of a substituted or unsubstituted alkyl group of a straight-chain or branch-chain having 1 to 30 carbon atoms; and n represents 0 or 1. A carbon chain in the above-mentioned Sp may be interrupted by oxygen in an ether functional group, sulfur in a thioether functional group, a non-adjacent imino group, a C₁-C₄ alkylimino group, or the like.

In the above-mentioned Formula (2), Z is preferably any of the following atomic groups. In the following Formula, examples of R include a methyl, ethyl, n-propyl, i-propyl, n-butyl, i-butyl, and t-butyl groups.

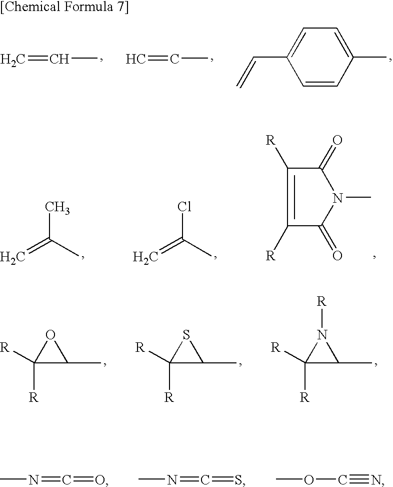

Further, in the above-mentioned Formula (2), Sp is preferably any of the following atomic groups represented by the following Formula, and in the following Formula, it is preferred that m represent to 3 and p represent 1 to 12.

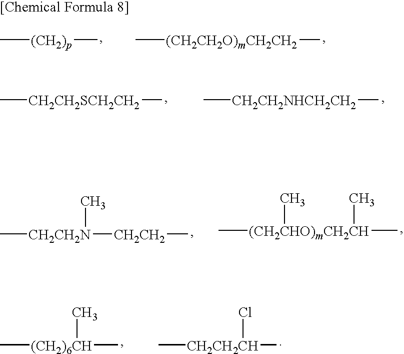

In the above-mentioned Formula (1), M is preferably represented by the following Formula (3). In the following Formula (3), X is the same as that defined in the above-mentioned Formula (1). Q represents, for example, substituted or unsubstituted straight-chain or branch-chain alkylene, or an aromatic hydrocarbon atomic group. Q may be substituted or unsubstituted straight-chain or branch-chain C₁-C₁₂ alkylene, and the like, for example.

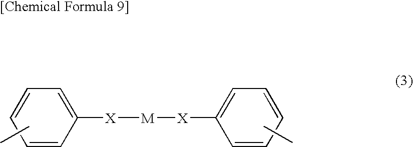

In the case where the above-mentioned Q is an aromatic hydrocarbon atomic group, the above-mentioned Q is preferably an atomic group represented by the following Formula, or a substituted analogue thereof.

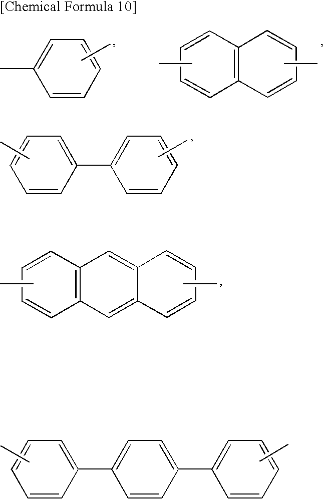

The substituted analogue of the aromatic hydrocarbon atomic group represented by the above-mentioned formula may have 1 to 4 substituents per aromatic ring, for example, and may have 1 or 2 substituent per aromatic ring or group. The substituents may be the same as or different from one another. Examples of the substituents include C₁-C₄ alkyl, nitro, a halogen such as F, Cl, Br, or I, phenyl, and C₁-C₄ alkoxy.

Specific examples of the liquid crystal monomer include monomers represented by the following Formulae (4) to (19).

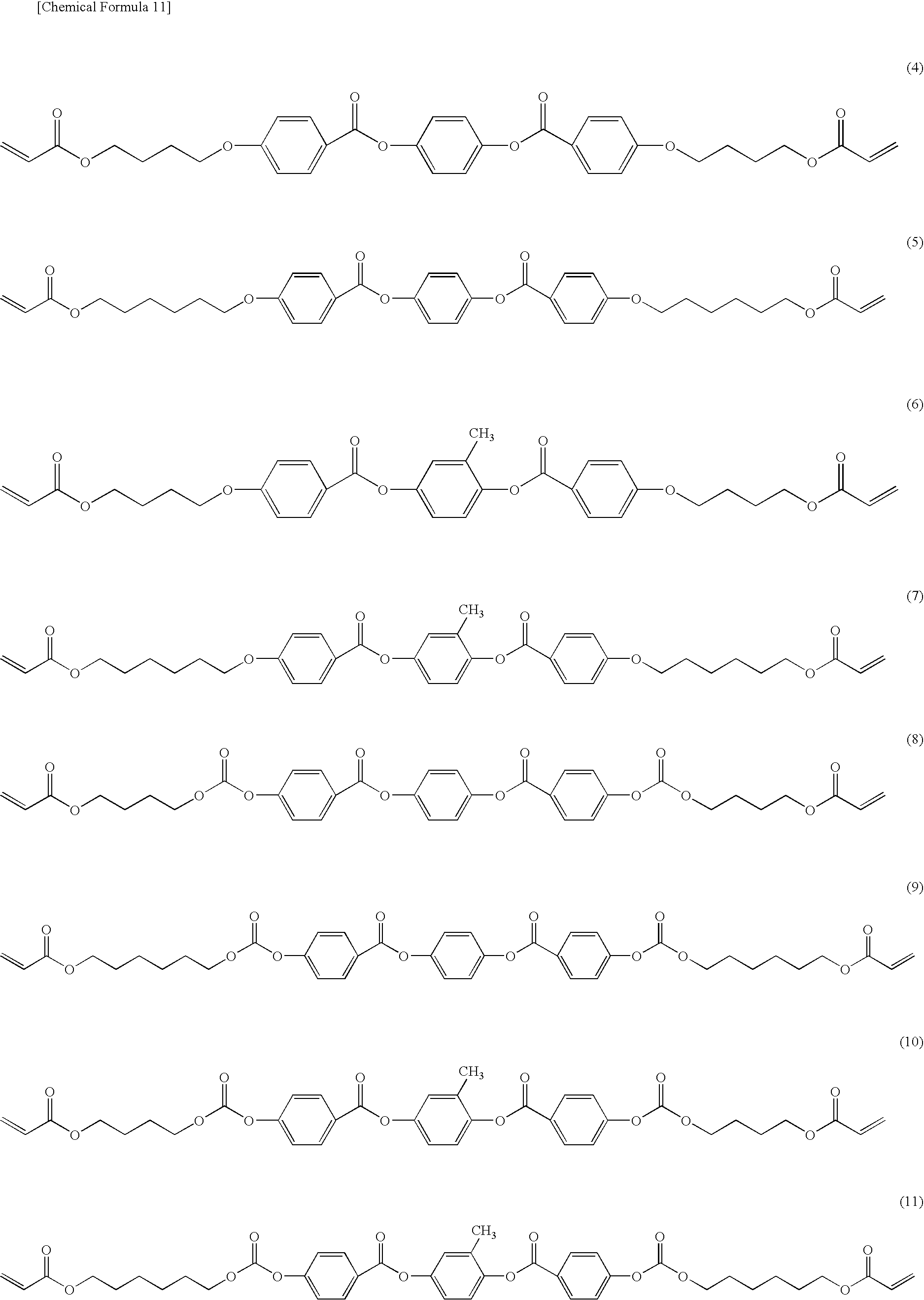

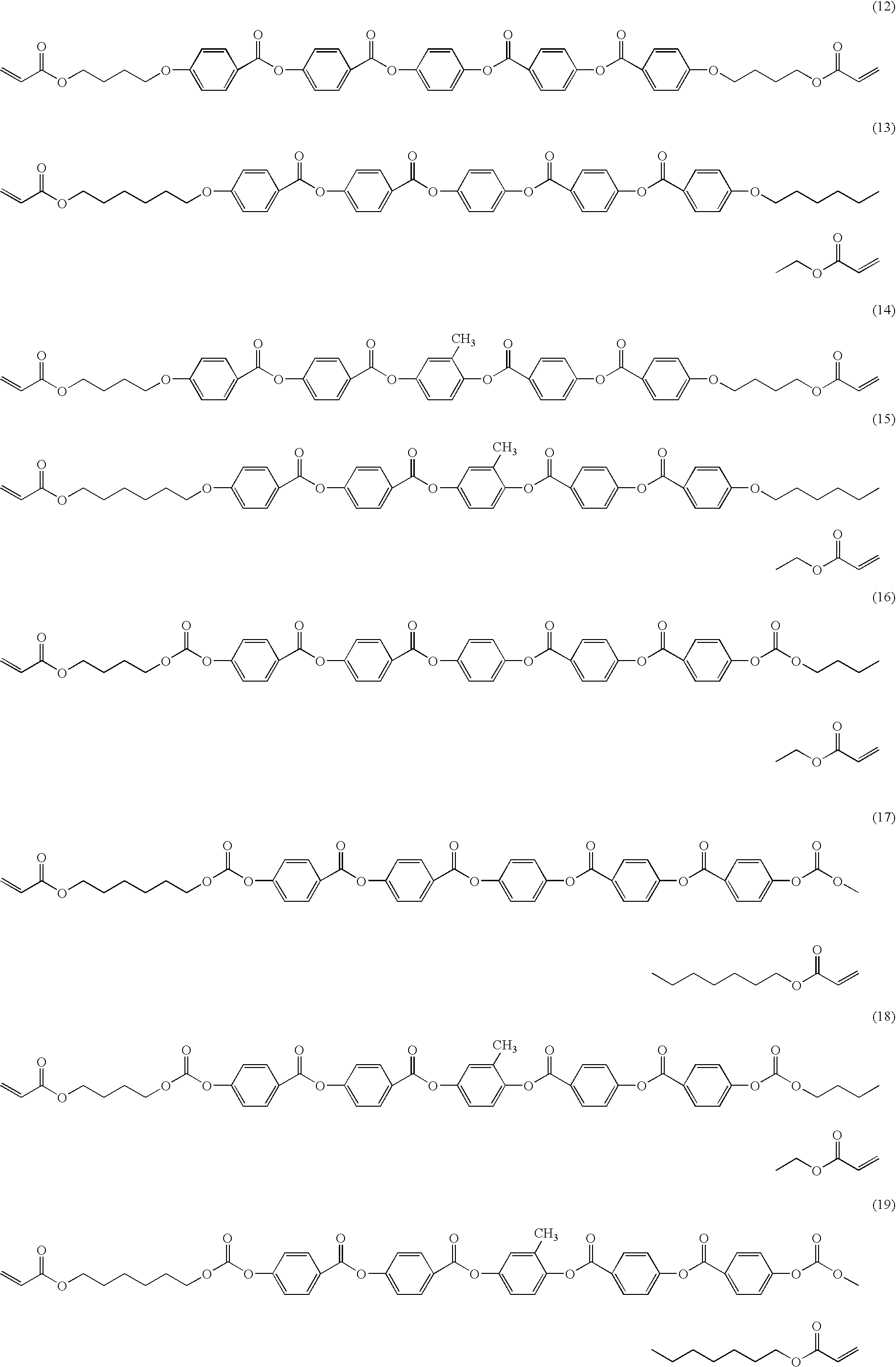

The temperature range in which the liquid crystal monomers exhibit crystallinity varies depending upon the kinds of the liquid crystal monomers. Specifically, the temperature range is preferably 40 to 120° C., more preferably 50 to 100° C., and most preferably 60 to 90° C.

### A-4. Third Birefringent Layer

As described above, the third birefringent layer 15 functions as a so-called λ/4 plate. According to the present invention, the wavelength dispersion properties of the third birefringent layer that functions as a λ/4 plate are amended by the optical properties of the second birefringent layer that functions as λ/2 plate, whereby a circular polarization function can be exhibited in a wide wavelength range. An in-plane retardation (Δnd) of the third birefringent layer is preferably 90 to 180 nm, more preferably 90 to 150 nm, and most preferably 105 to 135 nm at a wavelength of 550 nm. An Nz coefficient (=(nx−nz)/(nx−ny)) of the third birefringent layer is preferably 1.0 to 2.2, more preferably 1.2 to 2.0, and most preferably 1.4 to 1.8. Further, it is preferred that the third birefringent layer 15 have a refractive index profile of nx>ny>nz.

The thickness of the third birefringent layer can be set in order that the layer can also function as a λ/4 plate most appropriately. In other words, the thickness can be set in order to obtain a desired in-plane retardation. Specifically, the thickness is preferably 10 to 100 μm, more preferably 20 to 80 μm, and most preferably 40 to 70 μm.

The third birefringent layer can be formed, typically, by stretching a polymer film. For example, by appropriately selecting the kind of a polymer, stretching conditions (for example, stretching temperature, stretching ratio, and stretching direction), a stretching method, and the like, a third birefringent layer having desired optical properties (for example, a refractive index profile, an in-plane retardation, a thickness direction retardation, and an Nz coefficient) may be obtained. More specifically, the stretching temperature is preferably 120 to 180° C., and more preferably 140 to 170° C. The stretching ratio is preferably 1.05 to 2.0 times, and more preferably 1.3 to 1.6 times. An example of the stretching method includes a lateral uniaxial stretching. The stretching direction is preferably a direction substantially perpendicular to an absorption axis of a polarizer (a widthwise direction of a polymer film, i.e., a direction perpendicular to a lengthwise direction).

As a polymer constituting the polymer film, any suitable polymer can be adopted. Specific examples of the polymer film include positive birefringence films formed of a polycarbonate-based polymer, a norbornene-based polymer, a cellulose-based polymer, a polyvinyl alcohol-based polymer, and a polysulfon-based polymer. A polycarbonate-based polymer and a norbornene-based polymer are preferred.

### A-5. Polarizer

Any appropriate polarizer may be employed as the polarizer 11 in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based aligned film such as a dehydrated product of a polyvinyl alcohol-based film or a dehydrochlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. The thickness of the polarizer is not particularly limited, but is generally about 1 to 80 μM.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination on a film surface or washing away of an antiblocking agent, but also provides an effect of preventing uneveness such as uneven coloring by swelling the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

### A-6. Protective Layer

The protective layer 12 and the second protective layer 16 are each formed of any appropriate film which can be used as a protective film for a polarizing plate. The film is preferably a transparent protective film. Specific examples of a material used as a main component of the film include a cellulose-based resin such as triacetylcellulose (TAC), and transparent resins such as a polyester-based resin, a polyvinyl alcohol-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, an acrylic resin, and an acetate-based resin. An other example thereof includes an acrylic, urethane-based, acrylic urethane-based, epoxy-based, or silicone-based thermosetting resin or UV-curing resin. Still another example thereof includes a glassy polymer such as a siloxane-based polymer. Further, a polymer film described in JP 2001-343529 A (WO 01/37007) may also be used. To be specific, the film is formed of a resin composition containing a thermoplastic resin having a substituted or unsubstituted imide group on a side chain, and a thermoplastic resin having a substituted or unsubstituted phenyl group and a nitrile group on a side chain. A specific example thereof includes a resin composition containing an alternate copolymer of isobutene and N-methylmaleimide, and an acrylonitrile/styrene copolymer. The polymer film may be an extruded product of the above-mentioned resin composition, for example. Of those, TAC, a polyimide-based resin, a polyvinyl alcohol-based resin, and a glassy polymer are preferable, and TAC is most preferable. This is because the circular polarization properties in an oblique direction are enhanced remarkably by using the above-mentioned polymer film in combination with the first birefringent layer.

The protective layer is preferably transparent and color less. To be specific, the protective layer has a thickness direction retardation of preferably −90 nm to +90 nm, more preferably −80 nm to +80 nm, and most preferably −70 nm to +70 nm.

The protective layer has any appropriate thickness as long as the preferable thickness direction retardation can be obtained. To be specific, the thickness of the protective layer is preferably 1 to 100 μm, more preferably 5 to 80 μm, and most preferably 10 to 50 μm.

### B. Method of Producing Elliptically Polarizing Plate

A method of producing an elliptically polarizing plate in one embodiment of the present invention includes the steps of: forming a first birefringent layer on the surface of a transparent protective film (that is to be the protective layer 12 finally); laminating a polarizer on the surface of the transparent protective film on an opposite side of the first birefringent layer; forming a second birefringent layer on the surface of the first birefringent layer; and forming a third birefringent layer on the surface of the second birefringent layer. According to such a production method, for example, the elliptically polarizing plate as shown in FIG. 1 can be obtained. The order of the respective steps can be changed appropriately depending upon the purpose. For example, the step of laminating the polarizer may be performed after the step of forming or laminating any of the birefringent layers. Hereinafter, the detail of each step will be described. As an example, a production procedure of the elliptically polarizing plate as shown in FIG. 1 will be described.

### B-1. Formation of First Birefringent Layer

First, the first birefringent layer 13 is formed on the surface of the transparent protective film (that is to be the protective layer 12 finally). Typically, the first birefringent layer is formed by applying the liquid crystal material (a liquid crystal monomer or a liquid crystal polymer) and/or the liquid crystalline composition described in the item A-2 to the transparent protective film, allowing them to be aligned homeotropically while they exhibit a liquid crystal phase, and immobilizing them while the alignment is maintained. Alternatively, the first birefringent layer is formed by transferring a homeotropically aligned immobilized film formed on a substrate to the transparent protective film. Hereinafter, for simplicity, only the case of forming the first birefringent layer directly on the transparent protective film will be described.

Examples of the method of applying the liquid crystal material (a liquid crystal monomer or a liquid crystal polymer) or the liquid crystalline composition to the transparent protective film include a solution applying method using a solution in which the liquid crystal material or the liquid crystalline composition is dissolved in a solvent, or a method of melting the liquid crystal material or the liquid crystalline composition and applying the melted material or composition. The solution applying method is preferred. This is because the homeotropic alignment can be realized precisely and easily.

The solvent to be used in preparing the solution of the above-mentioned solution applying may be any suitable solvent capable of dissolving the liquid crystal material or the liquid crystalline composition. Specific examples include: halogenated hydrocarbons such as chloroform, dichloromethane, dichloroethane, tetrachloroethane, trichloroethylene, tetrachloroethylene, and chlorobenzene; phenols such as phenol, parachlorophenol; aromatic hydrocarbons such as benzene, toluene, xylene, methoxybenzene, and 1,2-dimethoxybenzene; other solutions such as acetone, ethyl acetate, t-butyl alcohol, glycerin, ethylene glycol, triethylene glycol, ethylene glycol monomethyl ether, diethylene glycol dimethyl ether, ethyl cellosolve, butyl cellosolve, 2-pyrrolidone, N-methyl-2-pyrrolidone, pyridine, triethylamine, tetra hydrofuran, dimethylformamide, dimethylacetamide, dimethyl sulfoxide, acetonitrile, butyronitrile, carbon bisulfide, and cyclohexanone. The concentration of the solution may vary with the type (solubility) of the liquid crystal material or the like to be used and a desired thickness and the like. Specifically, the concentration of the solution is preferably 3 to 50% by weight, and more preferably 7 to 30% by weight.

Examples of the method of applying the above-mentioned solution to the transparent protective film include roll coating, gravure coating, spin coating, and bar coating. The gravure coating and the bar coating are preferred. This is because the solution is easily applied to a large area uniformly. After application, a solvent is removed, and a liquid crystal material layer or a liquid crystalline composition layer is formed on the transparent protective film. The condition for removing the solvent is not particularly limited as long as the solvent can be removed substantially, and the liquid crystal material layer or the liquid crystalline composition does not flow or drop. Usually, the solvent is removed by drying at room temperature, drying in a dry furnace, heating on a hot plate, or the like.

Then, the liquid crystal material layer or the liquid crystalline composition layer formed on the transparent protective film is formed into a liquid crystal state and aligned homeotropically. For example, the liquid crystal polymer or the liquid crystalline composition is heat-treated to a temperature at which they exhibit a liquid crystal state, and they are aligned homeotropically in the liquid crystal state. The heat-treatment method can be performed in the same way as in the above-mentioned drying method. The heat-treatment temperature can change depending upon the kinds of the liquid crystal material or the liquid crystalline composition and the transparent protective film to be used. Specifically, the heat-treatment temperature is preferably 60° C. to 300° C., more preferably 70° C. to 200° C., and most preferably 80° C. to 150° C. The heat-treatment time can also change depending upon the kind of the liquid crystal material or the liquid crystalline composition and the transparent protective film to be used. Specifically, the heat-treatment time is preferably 10 seconds to 2 hours, more preferably 20 seconds to 30 minutes, and most preferably 30 seconds to 10 minutes. In the case where the heat-treatment time is shorter than 10 seconds, there is a possibility that the formation of homeotropic alignment may not proceed sufficiently. Even if the heat-treatment time is longer than 2 hours, the formation of homeotropic alignment may not proceed any more in many cases, and hence the heat-treatment time longer than 2 hours is not preferred in terms of operability and mass-productivity.

After the completion of the heat-treatment, a cooling operation is performed. The cooling operation can be performed by taking the homeotropically aligned liquid crystal layer after the heat treatment from the heating atmosphere in the heat-treatment operation to the room temperature atmosphere. Further, forceful cooling such as air cooling and water cooling may be performed. The homeotropically aligned liquid crystal layer has the alignment immobilized by being cooled to the glass transition temperature or lower of the liquid crystal material.

In the case of using the liquid crystalline composition, the homeotropically aligned liquid crystal layer immobilized as described above is irradiated with light or UV-rays, whereby a photopolymerizable liquid crystal compound is immobilized by polymerization or cross-linking, and durability can be enhanced further. For example, it is preferred that the condition of UV-irradiation is set to be an inactive gas atmosphere so as to promote the polymerization or cross-linking reaction sufficiently. As the means for UV-irradiation, typically, a high-pressure mercury UV-lamp having an illuminance of about 80 to 160 mW/cm² is used. Further, various kinds of other lamps such as a metal halide UV lamp and an incandescent lamp can also be used. It is preferred to regulate temperature so that the temperature of the surface of the liquid crystal layer during UV-irradiation becomes a temperature range in which a liquid crystal state is exhibited. Examples of the method of regulating temperature include a cold mirror, water cooling, other cooling treatments, or the increase in a line speed.

A thin film of the liquid crystal material or the liquid crystalline composition is formed as described above, and is immobilized while the homeotropic alignment is maintained, whereby the homeotropically aligned first birefringent layer 13 is formed on the transparent protective film 12.

### B-2. Formation of Second Birefringent Layer

Next, the second birefringent layer 14 is formed on the surface of the first birefringent layer 13. The second birefringent layer can be formed typically by applying a coating solution containing a predetermined liquid crystal material to a substrate subjected to alignment treatment to form a birefringent layer having a slow axis that forms an angle α with respect to the absorption axis of the polarizer 11 as shown in FIG. 2, and transferring the birefringent layer from the substrate to the surface of the first birefringent layer. Alternatively, the second birefringent layer may be formed by subjecting the surface of the first birefringent layer to alignment treatment, and applying the coating solution containing a predetermined liquid crystal material to the aligned surface. Hereinafter, for simplicity, only the case of transferring the second birefringent layer will be described.

### B-2-1. Alignment Treatment on Substrate

Any appropriate substrate may be employed as the substrate.

Specific examples thereof include a plastic sheet and a plastic film. The thickness of the substrate is generally about 10 to 1,000 μm.

Any appropriate film may be used for the plastic film as long as the plastic film does not change at the temperature at which the above-mentioned liquid crystal material is aligned. A specific example thereof is a film formed of a transparent polymer such as: a polyester-based polymer such as polyethylene terephthalate or polyethylene naphthalate; a cellulose-based polymer such as diacetyl cellulose or triacetyl cellulose; a polycarbonate-based polymer; or an acrylic polymer such as polymethyl methacrylate. An other specific example thereof is a film formed of a transparent polymer such as: a styrene-based polymer such as polystyrene or an acrylonitrile/styrene copolymer; an olefin-based polymer such as polyethylene, polypropylene, a polyolefin having a cyclic or norbornene structure, or an ethylene/propylene copolymer; a vinyl chloride-based polymer; or an amide-based polymer such as nylon or aromatic polyamide. Still another specific example thereof is a film formed of a transparent polymer such as an imide-based polymer, a sulfone-based polymer, a polyethersulfone-based polymer, a polyetheretherketone-based polymer, a polyphenylene sulfide-based polymer, a vinyl alcohol-based polymer, a vinylidene chloride-based polymer, a vinyl butyral-based polymer, an arylate-based polymer, a polyoxymethylene-based polymer, an epoxy-based polymer, or a blended product thereof. Of those, plastic films of triacetyl cellulose, polycarbonate, norbornene-based polyolefin, and the like, which have a high hydrogen bonding property and are used as optical films, are used preferably.

As the alignment treatment on the substrate, any suitable alignment treatment can be adopted. Specifically, there are mechanical alignment treatment, physical alignment treatment, and chemical alignment treatment. Specific examples of the mechanical alignment treatment include rubbing treatment and stretching treatment. Specific examples of the physical alignment treatment include magnetic field alignment treatment and electric field alignment treatment. Specific examples of the chemical alignment treatment include oblique deposition and optical alignment treatment. The rubbing treatment is preferred. As the treatment conditions for various kinds of alignment treatments, any suitable condition can be adopted depending upon the purpose.

A method for the above-mentioned rubbing treatment is preferably the following method: in a rubbing treatment step of rubbing the surface of a continuous substrate film with rubbing rolls, the above-mentioned continuous substrate film is supported and conveyed by a conveying belt having a metal surface, multiple back-up rolls are provided so as to support the lower surface of the conveying belt supporting the above-mentioned continuous substrate film and to be opposite to the above-mentioned rubbing rolls, and a rubbing strength RS defined by the following equation (1) is set to preferably 800 mm or more, more preferably 850 mm or more, still more preferably 1,000 mm or more, or particularly preferably 2,200 mm or more:

RS=N·M(1+2πr·nr/v) (1)

where N represents the number of times of rubbing (number of rubbing rolls) (dimensionless quantity), M represents the indentation amount of each rubbing roll (mm), π represents a circle ratio, r represents the radius of each rubbing roll (mm), nr represents the number of revolutions of each rubbing roll (rpm), and v represents the rate at which the continuous substrate film is conveyed (mm/sec) It should be noted that r represents the radius of a rubbing roll including a raised fabric portion (mm) when a raised fabric is wound around the rubbing roll as will be described later.

According to the above-mentioned method, (1) the multiple back-up rolls for supporting the lower surface of the conveying belt supporting and conveying the continuous substrate film are provided when the film in subjected to the rubbing treatment, so the film can be subjected to the rubbing treatment in a stable state even when the indentation amount of each rubbing roll is increased, (2) a uniform alignment property (uniform optical properties) can be obtained by setting a value for the above-mentioned parameter referred to as “rubbing strength” to a predetermined value or higher even when the continuous substrate film undergoes blocking, and (3) the continuous substrate film can be continuously subjected to the rubbing treatment according to a roll-to-roll mode, so the rubbing treatment can be realized at a low cost. When the position of each rubbing roll is changed with respect to the surface of the above-mentioned continuous substrate film, the position at which the rubbing roll initially comes into contact with the surface of the continuous substrate film is defined as an origin (zero point). It should be noted that the amount by which the rubbing roll is indented from the above-mentioned origin toward the continuous substrate film (amount by which the position of the rubbing roll is changed) is defined as the indentation amount of the term “indentation amount of each rubbing roll” in the above-mentioned method. It should be noted that, when a raised fabric is wound around the rubbing roll as will be described later, the position at which the hair tip of the raised fabric wound around the rubbing roll initially comes into contact with the surface of the continuous substrate film is defined as an origin (zero point).

In the method for the above-mentioned rubbing treatment, multiple rod-like back-up rolls for supporting the lower surface of the conveying belt supporting and conveying the continuous substrate film are provided so as to be substantially parallel to each other when the film is subjected to the rubbing treatment, whereby the flatness of the conveying belt supported by the back-up rolls easily improves. In this case, when the center-to-center-to-center distance between two adjacent back-up rolls is set to be less than 50 mm, the outer diameter of each of the back-up rolls must be necessarily reduced. In this case, when the rate at which the continuous substrate film is conveyed is assumed to be constant, each of the back-up rolls rotates at a higher speed at the time of the rubbing treatment than that in the case where the back-up rolls each have a large outer diameter, so a problem such as the deformation of the continuous substrate film supported by the conveying belt due to heat generated upon rotation of the rolls may occur. On the other hand, in the case where the center-to-center-to-center distance between two adjacent back-up rolls is set to be more than 90 mm, the following problem occurs: the flatness of the conveying belt reduces, so alignment unevenness occurs in the film, and the external appearance of the film is apt to deteriorate. Therefore, the center-to-center-to-center distance between two adjacent back-up rolls is set to be preferably 50 mm or more and 90 mm or less, or more preferably 60 mm or more and 80 mm or less in order that such problems may be avoided. With such preferred constitution, an additionally uniform alignment property can be imparted to the continuous substrate film, and consequently, an optical compensation layer having additionally uniform optical properties can be formed.

In the case where the outer diameter (diameter) of each of the above-mentioned back-up rolls is set to be less than 30 mm, when the rate at which the continuous substrate film is conveyed is assumed to be constant, each of the back-up rolls rotates at a higher speed at the time of the rubbing treatment than that in the case where the back-up rolls each have a large outer diameter, so a problem such as the deformation of the continuous substrate film supported by the conveying belt due to heat generated upon rotation of the rolls may occur. On the other hand, in the case where the outer diameter of each of the back-up rolls is set to be more than 80 mm, the following problem occurs: the flatness of the conveying belt reduces, so alignment unevenness occurs in the film, and the external appearance of the film is apt to deteriorate. Therefore, the outer diameter of each of the above-mentioned back-up rolls is set to be preferably 30 mm or more and 80 mm or less, or more preferably 40 mm or more and 70 mm or less in order that such problems may be avoided.

In the present invention, a raised fabric is preferably wound around each of the above-mentioned rubbing rolls. For example, a raised fabric made of any one of rayon, cotton, nylon, and a mixture of them is preferably used as the above-mentioned raised fabric.

The above-mentioned conveying belt has a thickness in the range of preferably 0.5 to 2.0 mm, or more preferably 0.7 to 1.5 mm with a view to imparting flexibility to the belt while preventing the belt from easily sagging.

Hereinafter, an example of the above-mentioned rubbing method will be described with reference to the drawings.

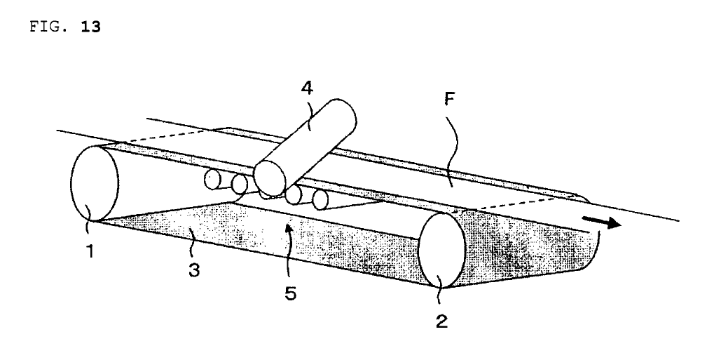

FIG. 13 is a perspective view showing the outline constitution of a rubbing treatment apparatus for carrying out the above-mentioned method for a rubbing treatment. As shown in FIG. 13, the above-mentioned rubbing treatment apparatus is provided with: driving rolls 1 and 2; an endless conveying belt 3 which is suspended between the driving rolls 1 and 2 and which supports and conveys a continuous substrate film F; a rubbing roll 4 provided above the conveying belt 3 so as to be capable of vertically ascending and descending; and multiple (five in this example) rod-like back-up rolls 5 provided so as to support the lower surface of the conveying belt 3 supporting the continuous substrate film F and to be opposite to the rubbing roll 4. It should be noted that a proper static eliminator, a proper dust arrester, or the like may be installed in front of or behind the rubbing treatment apparatus as required. In the present invention, the rubbing treatment apparatus is preferably provided with two to six back-up rolls.

The surface of the conveying belt 3 on the side where the continuous substrate film F is supported is a mirror-finished metal surface (the entirety of the conveying belt 3 may be made of a metal). Any one of various metal materials such as copper and steel can be used as such metal; stainless steel is preferably used in terms of strength, hardness, and durability. In order that adhesiveness between the conveying belt 3 and the continuous substrate film F may be secured, the extent to which the surface is mirror-finished is such that an arithmetic average surface roughness Ra (JIS B 0601 (version of the year 1994)) of the surface of the conveying belt 3 is preferably 0.02 μm or less, or more preferably 0.01 μm or less. In addition, the conveying belt 3 supporting the continuous substrate film F must be prevented from sagging in order that the film may be prevented from sagging. In view of the need for imparting some degree of flexibility to the conveying belt 3 in order that the conveying belt 3 may be suspended between the driving rolls 1 and 2 as well as the need for preventing the conveying belt 3 from sagging, the conveying belt 3 has a thickness in the range of preferably 0.5 to 2.0 mm, or more preferably 0.7 to 1.5 mm. In addition, in consideration of the tensile strength of the conveying belt 3 as well as the prevention of the sag of the conveying belt 3, a tension to be applied to the conveying belt 3 is in the range of preferably 0.5 to 20 kg-wt/mm², or more preferably 2 to 15 kg-wt/mm².

A raised fabric is preferably wound around the outer peripheral surface of the rubbing roll 4. It is sufficient to select the material, shape, and the like of the raised fabric appropriately depending on the material of the continuous substrate film F to be subjected to the rubbing treatment. In general, a fabric made of rayon, cotton, nylon, a mixture of them, or the like is applicable to the raised fabric. The rotation axis of the rubbing roll 4 according to this example is constituted so as to be capable of being inclined from the vertical direction (by an inclination angle of, for example, 0° to 50°) with respect to the direction in which the continuous substrate film F is conveyed (direction indicated by the arrow in FIG. 13), that is, so as to be capable of being set at an arbitrary axial angle with respect to the long side (longitudinal direction) of the continuous substrate film F. In addition, the rotation direction of the rubbing roll 4 can be appropriately selected depending on conditions for the rubbing treatment.

As described above, the multiple back-up rolls 5 are provided so as to support the lower surface of the conveying belt 3 supporting the continuous substrate film F and to be opposite to the rubbing roll 4. Providing the multiple back-up rolls 5 enables the continuous substrate film F to be subjected to the rubbing treatment in a stable state even when the rubbing roll 4 is indented with its rotation axis inclined, or the indentation amount of the rubbing roll 4 is increased.

In subjecting the continuous substrate film F to the rubbing treatment with the above-mentioned rubbing apparatus, the continuous substrate film F wound around a predetermined roll (not shown) is supplied onto the conveying belt 3 through multiple conveying rolls (not shown). Then, the driving rolls 1 and 2 are rotated, whereby the upper portion of the conveying belt 3 moves in the direction indicated by the arrow in FIG. 13. In association with the movement, the continuous substrate film F is also conveyed along the conveying belt 3 to be subjected to the rubbing treatment with the rubbing roll 4.

In the rubbing treatment step of this example, a rubbing strength RS defined by the following equation (1) is set to preferably 800 nm or more, more preferably 850 nm or more, still more preferably 1,000 nm or more, or particularly preferably 2,200 nm or more:

RS=N·M(1+2πr·nr/v) (1)

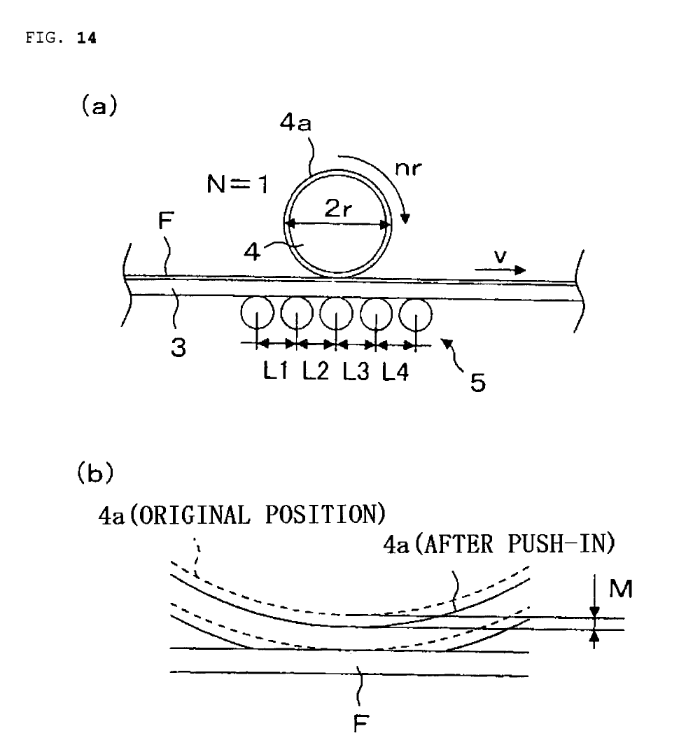

FIG. 14 are each a front view partially showing the rubbing treatment apparatus shown in FIG. 13. FIG. 14(a) is a front view showing the vicinity of the rubbing roll 4, and FIG. 14(b) is an enlarged front view showing the vicinity of a portion where the rubbing roll 4 and the surface of the continuous substrate film F are in contact with each other. As described above, in the above-mentioned equation (1), N represents the number of times of rubbing (corresponding to the number of the rubbing rolls 4, which is 1 in this example) (dimensionless quantity), M represents the indentation amount of the rubbing roll 4 (mm), n represents a circle ratio, r represents the radius of the rubbing roll 4 (including a raised fabric 4a) (mm), nr represents the number of revolutions of the rubbing roll (rpm), and v represents the rate at which the continuous substrate film F is conveyed (mm/sec). It should be noted that the indentation amount M of the rubbing roll is defined as follows: when the position of the rubbing roll 4 is changed with respect to the surface of the continuous substrate film F as shown in FIG. 14(b), the position at which the hair tip of the raised fabric 4a wound around the rubbing roll 4 initially contacts with the surface of the continuous substrate film F (position indicated by a broken line in FIG. 14(b)) is defined as an origin (zero point), and the amount in which the rubbing roll 4 is indented from the above-mentioned origin toward the continuous substrate film F (amount in which the roll is indented as far as the position indicated by a solid line in FIG. 14(b)) is defined as the indentation amount M.

In the case where the rubbing strength RS is set to preferably 800 nm or more, more preferably 850 nm or more, still more preferably 1,000 nm or more, or particularly preferably 2,200 nm or more as described above, even when the continuous substrate film F undergoes blocking, a uniform alignment property can be imparted to the film, and, consequently, an optical compensation layer having uniform optical properties can be produced. It should be noted that the material for the continuous substrate film F as an object to which the rubbing treatment according to this example is applied is not particularly limited as long as a function by which a liquid crystal compound applied onto the surface of the film can be aligned by subjecting the surface or an alignment film formed on the surface to the rubbing treatment is imparted to the film, and the above-mentioned continuous substrate film is applicable.

It should be noted that the other conditions for the rubbing treatment (respective parameters) can be appropriately selected as long as the rubbing strength RS is set to preferably 800 nm or more, more preferably 850 nm or more, still more preferably 1,000 nm or more, or particularly preferably 2,200 nm or more; the above-mentioned rate v at which the continuous substrate film F is conveyed is, for example, in the range of preferably 1 to 50 m/min, or more preferably 1 to 10 m/min; the number of revolutions nr of the rubbing roll 4 is, for example, in the range of preferably 1 to 3,000 rpm, more preferably 500 to 2,000 rpm; and the indentation amount M of the rubbing roll 4 is, for example, in the range of preferably 100 to 2,000 μm, or more preferably 100 to 1,000 μm.

It should be noted that a preferred constitution in this example is such that the center-to-center-to-center distance between respective adjacent rolls of the multiple rod-like back-up rolls 5 provided so as to be substantially parallel to one another (any one of L1 to L4 of FIG. 14(a)) is set to preferably 50 mm or more and 90 mm or less, or more preferably 60 mm or more and 80 mm or less. Such constitution easily improves the flatness of the conveying belt 3 supported by the back-up rolls 5. In addition, each of the center-to-center distances L1 to L4 is set to 50 mm or more (the setting necessarily enlarges the outer diameter of each of the back-up rolls 5 to some extent), so none of the back-up rolls 5 rotates at a high speed at the time of the rubbing treatment, and a problem such as the deformation of the continuous substrate film F supported by the conveying belt 3 due to heat generated upon rotation of the rolls hardly occurs. Further, each of the center-to-center distances L1 to L4 is set to 90 mm or less, so a uniform alignment property can be imparted to the continuous substrate film F without any reduction in flatness of the conveying belt 3. The outer diameter of each of the back-up rolls 5 is set to preferably 30 mm or more and 80 mm or less, or more preferably 40 mm or more and 70 mm or less. When the outer diameter of each of the back-up rolls 5 is set to 30 mm or more, none of the back-up rolls 5 rotates at a high speed at the time of the rubbing treatment, and a problem such as the deformation of the continuous substrate film F supported by the conveying belt 3 due to heat generated upon rotation of the rolls hardly occurs. In addition, when the outer diameter of each of the back-up rolls 5 is set to 80 mm or less, a uniform alignment property can be imparted to the continuous substrate film F without any reduction in flatness of the conveying belt 3. The description has been given by taking the case where the back-up rolls 5 are each composed of a rod-like roll as an example of this example. However, the present invention is not limited to the above-mentioned example, and a plate provided with multiple spherical bodies (bearing plate) is also applicable to the back-up rolls 5.

The alignment direction of the alignment treatment is a direction in which, when a long substrate and a long polarizer are laminated, the alignment treatment forms a predetermined angle with respect to the absorption axis of the polarizer. The alignment direction is substantially the same as the direction of the slow axis of the second birefringent layer 14 to be formed, as described later. Thus, the predetermined angle is preferably +8° to +38° or −8° to −38°, more preferably +13° to +33° or −13° to −33°, particularly preferably +19° to +29° or −19° to −29°, especially preferably +21° to +27° or −21° to −27°, and most preferably +23° to +24° or −23° to −24°.

It is preferred that the alignment treatment capable of defining the above-mentioned predetermined angle with respect to the long substrate is performed in an oblique direction (specifically, a direction in which the above-mentioned predetermined angle is defined) with respect to the longitudinal direction of the long substrate. The polarizer is produced by stretching a polymer film dyed with the above-mentioned dichroic substance, and has an absorption axis in the stretching direction thereof. When polarizers are produced in quantities, along polymer film is prepared, and stretching is performed continuously in a longitudinal direction thereof. Thus, by performing the alignment treatment in an oblique direction, the second birefringent layer and the polarizer to be formed on a substrate can be laminated by so-called roll-to-roll. The direction of the absorption axis of the polarizer is substantially matched with the longitudinal direction of a long film (polarizer, substrate/second birefringent layer), and hence the alignment treatment may be performed at the above-predetermined angle with respect to the longitudinal direction. On the other hand, when the alignment treatment is performed in the longitudinal direction of the long substrate or the perpendicular direction (width direction) thereof, it is necessary that the lamination should be performed after the substrate is cut out in an oblique direction. Consequently, the angle of an optical axis may vary in each cut-out film, and as a result, the quality of the product varies one by one, cost and time are entailed, and the amount of waste increases, which makes it difficult to produce a large film.

The alignment treatment may be performed directly with respect to the surface of the substrate, or any suitable alignment film (typically, a silane coupling agent layer, a polyvinyl alcohol layer, or a polyimide layer) may be formed and the alignment film may be subjected to the alignment treatment. For example, it is preferred that the rubbing treatment is performed directly with respect to the surface of the substrate.

### B-2-2. Step of Applying the Liquid Crystal Material Forming Second Birefringent Layer

Next, a coating solution containing a liquid crystal material as descried in the item A-3 is applied to the surface of the substrate subjected to the above-mentioned alignment treatment, and then, the liquid crystal material is aligned to form a second birefringent layer. Specifically, a coating solution in which a liquid crystal material is dissolved or dispersed in an appropriate solvent is prepared, and the coating solution may be applied to the surface of the substrate subjected to the above-mentioned alignment treatment. The step of aligning the liquid crystal material will be described in the item B-2-3 described later.

Any appropriate solvent which may dissolve or disperse the liquid crystal material may be employed as the solvent. The type of solvent to be used may be appropriately selected in accordance with the kind of the liquid crystal material or the like. Specific examples of the solvent include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, butyl acetate, and propyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrole; ether-based solvents such as diethyl ether, dibutyl ether, tetrahydrofuran, and dioxane; and carbon disulfide, ethyl cellosolve, butyl cellosolve, and ethyl cellosolve acetate. Of those, toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate are preferable. They may be used alone or in combination.

The content of the liquid crystal material in the application liquid may be appropriately determined in accordance with the kind of the liquid crystal material, the thickness of the target layer, and the like. Specifically, the content of the liquid crystal material is preferably 5 to 50 wt %, more preferably 10 to 40 wt %, and most preferably 15 to 30 wt %.

The application liquid may further contain any appropriate additive as required. Specific examples of the additive include a polymerization initiator and a cross-linking agent. Those additives are particularly preferably used when a liquid crystal monomer is used as the liquid crystal material. Specific examples of the polymerization initiator include benzoylperoxide (BPO) and azobisisobutyronitrile (AIBN). Specific examples of the cross-linking agent include an isocyanate-based cross-linking agent, an epoxy-based cross-linking agent, and a metal chelate cross-linking agent. They may be used alone or in combination. Specific examples of other additives include an antioxidant, a modifier, a surfactant, a dye, a pigment, a discoloration inhibitor, and a UV absorber. They may also be used alone or in combination. Examples of the antioxidant include a phenol-based compound, an amine-based compound, an organic sulfur-based compound, and a phosphine-based compound. Examples of the modifier include glycols, silicones, and alcohols. The surfactant is used for smoothing the surface of an optical film, for example. Specific examples thereof include a silicone-based surfactant, an acrylic surfactant, and a fluorine-based surfactant.

An application amount of the application liquid may be appropriately determined in accordance with the concentration of the application liquid, the thickness of the target layer, and the like. In the case where the concentration of the liquid crystal material is 20 wt % in the application liquid, the application amount is preferably 0.03 to 0.17 ml, more preferably 0.05 to 0.15 ml, and most preferably 0.08 to 0.12 ml per area of transparent protective film (100 cm²).

Any appropriate application method may be employed, and specific examples thereof include roll coating, spin coating, wire bar coating, dip coating, extrusion, curtain coating, and spray coating.

### B-2-3. Step of Aligning Liquid Crystal Material Forming Second Birefringent Layer

Next, the liquid crystal material forming the second birefringent layer is aligned in accordance with the alignment direction of the surface of the substrate. The liquid crystal material is aligned through treatment at a temperature at which a liquid crystal phase in accordance with the kind of liquid crystal material used is exhibited. The treatment at such a temperature allows the liquid crystal material to be in a liquid crystal state, and the liquid crystal material is aligned in accordance with the alignment direction of the surface of the transparent protective film. Thus, birefringence is caused in the layer formed through application, to thereby form the second birefringent layer.

As described above, the treatment temperature may be appropriately determined in accordance with the kind of liquid crystal material. Specifically, the treatment temperature is preferably 40 to 120° C., more preferably 50 to 100° C., and most preferably 60 to 90° C. The treatment time is preferably 30 seconds or more, more preferably 1 minute or more, particularly preferably 2 minutes or more, and most preferably 4 minutes or more. The treatment time of less than 30 seconds may provide an insufficient liquid crystal state of the liquid crystal material. Meanwhile, the treatment time is preferably 10 minutes or less, more preferably 8 minutes or less, and most preferably 7 minutes or less. The treatment time exceeding 10 minutes may cause sublimation of additives.

In the case where the liquid crystal monomer described in the section A-3 is used as the liquid crystal material, the layer formed through the application is preferably subjected to additional polymerization treatment or cross-linking treatment. The polymerization treatment allows the liquid crystal monomer to polymerize and to be fixed as a repeating unit of a polymer molecule. The cross-linking treatment allows the liquid crystal monomer to form a three-dimensional network structure and to be fixed as a part of a cross-linked structure. As a result, the alignment state of the liquid crystal material is fixed. The polymer or three-dimensional network structure formed through polymerization or cross-linking of the liquid crystal monomer is “non-liquid crystalline”. Thus, the formed second birefringent layer will not undergo phase transition into a liquid crystal phase, a glass phase, or a crystal phase by change in temperature, which is specific to a liquid crystal molecule.

A specific procedure for the polymerization treatment or cross-linking treatment may be appropriately selected in accordance with the kind of polymerization initiator or cross-linking agent to be used. For example, in the case where a photopolymerization initiator or a photocross-linking agent is used, photoirradiation may be performed. In the case where a UV polymerization initiator or a UV cross-linking agent is used, UV irradiation may be performed. The irradiation time, irradiation intensity, total amount of irradiation, and the like of light or UV ray may be appropriately set in accordance with the kind of liquid crystal material, the kind of transparent protective film, the kind of alignment treatment, desired properties for the first birefringent layer, and the like.

By performing the above-mentioned alignment treatment, the liquid crystal material is aligned in accordance with the alignment direction of the substrate, and hence the slow axis of the formed second birefringent layer becomes substantially the same as the alignment direction of the substrate. Thus, the direction of the slow axis of the second birefringent layer is preferably +8° to +38° or −8° to −38°, more preferably +13° to +33° or −13° to −33°, particularly preferably +19° to +29° or −19° to −29°, especially preferably +21° to +27° or −21° to −27°, and most preferably +23° to +24° or −23° to −24° with respect to the longitudinal direction of the long substrate (corresponding to the absorption axis direction of the polarizer).

Finally, the second birefringent layer is transferred from the substrate to the surface of the first birefringent layer, whereby the second birefringent layer is formed on the surface of the first birefringent layer (in other words, a laminate of the protective layer/first birefringent layer/second birefringent layer is formed).

### B-3. Step of Laminating Polarizer

Further, a polarizer is laminated on the surface of the transparent protective film (protective layer) opposite to the birefringent layer. As described above, the polarizer can be laminated at any suitable time in the production method of the present invention. For example, the polarizer may be previously laminated on the transparent protective film, may be laminated after the first birefringent layer is formed, or may be laminated after the second birefringent layer is formed.

As a method of laminating the transparent protective film and the polarizer, any suitable lamination method (for example, bonding) can be adopted. The bonding can be performed using any suitable adhesive or pressure-sensitive adhesive. The kind of the adhesive or pressure-sensitive adhesive can be appropriately selected depending upon the kind of an adherend (more specifically, transparent protective film and polarizer). Specific examples of the adhesive include acrylic, vinyl alcohol-based, silicone-based, polyester-based, polyurethane-based, and polyether-based polymer adhesives, an isocyanate-based adhesive, and a rubber-based adhesive. Specific examples of the pressure-sensitive adhesive include acrylic, vinyl alcohol-based, silicone-based, polyester-based, polyurethane-based, polyether-based, isocyanate-based, and rubber-based pressure-sensitive adhesives.

The thickness of the adhesive or pressure-sensitive adhesive is not particularly limited, but is preferably 10 to 200 nm, more preferably 30 to 180 nm, and most preferably 50 to 150 nm.

According to the above-mentioned production method, by the alignment treatment of the substrate (i.e., without cutting out the film obliquely), the slow axis of the second birefringent layer can be set, and hence a long polarizing film (polarizer) stretched in a lengthwise direction (i.e., having absorption axis in the lengthwise direction) can be used. That is, a long second birefringent layer (a long laminate including the second birefringent layer) aligned so as to form a predetermined angle with respect to the lengthwise direction, and a long polarizing film (polarizer) can be attached to each other continuously with each lengthwise direction being aligned. Thus, an elliptically polarizing plate is obtained at an extremely excellent production efficiency. Further, according to this method, it is not necessary to cut out the film obliquely to the lengthwise direction (stretching direction) to laminate the films. As a result, each cut film does not vary in an angle of an optical axis, whereby an elliptically polarizing plate without any variation in quality between products can be obtained. Further, because a waste caused by cutting is not generated, an elliptically polarizing plate is obtained at a low cost. In addition, the production of a large polarizing plate becomes easy.

The direction of the absorption axis of the polarizer is substantially parallel to the lengthwise direction of the long film. Herein, “substantially parallel” includes the case where the angle formed by the longitudinal direction and the direction of the absorption axis is 0°±10°, preferably 0°±5°, and more preferably 0°±3°.

### B-4. Step of Forming a Third Birefringent Layer

Further, a third birefringent layer is formed on the surface of the second birefringent layer. Typically, the third birefringent layer is formed by laminating the polymer film described in the item A-4 on the surface of the second birefringent layer. Preferably, the polymer film is a stretched film. More specifically, the polymer film is stretched in a widthwise direction as described in the item A-4. Such a stretched film has a slow axis in the widthwise direction, and hence the slow axis is substantially perpendicular to the absorption axis (lengthwise direction) of the polarizer. The lamination method is not particularly limited, and conducted using any suitable adhesive or pressure-sensitive adhesive (for example, the adhesive or pressure-sensitive adhesive described in the item B-3). As described above, the elliptically polarizing plate of the present invention is obtained.

### B-5. Specific Production Procedure

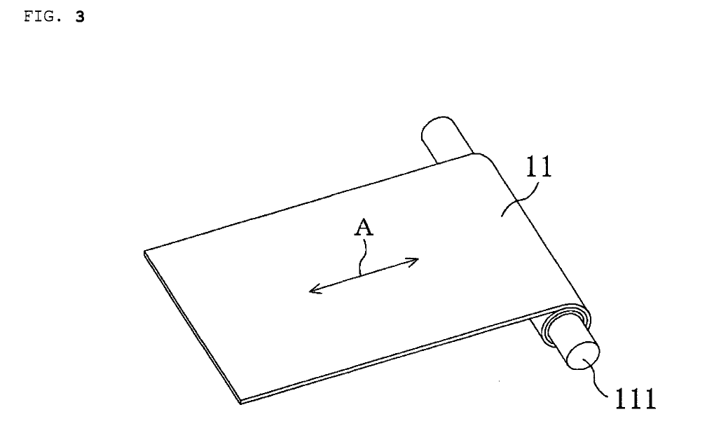

An example of a specific procedure for the production method of the present invention will be described by referring to FIGS. 3 to 7. For simplicity, only the case where the second birefringent layer is transferred onto the surface of the first birefringent layer will be described. Note that in FIGS. 3 to 7, reference numerals 111, 111′, 112, 113, 114, 115, 116, 117, 118, and 118′, each are rolls for rolling films forming respective layers and/or a laminate.

First, a long polymer film serving as a raw material for a polarizer is prepared, and is subjected to coloring, stretching, and the like as described in the item A-5. The long polymer film is subjected to continuous stretching in its lengthwise direction. In this way, as shown in a perspective view of FIG. 3, a long polarizer 11 having an absorption axis in a lengthwise direction (stretching direction: direction of arrow A) is obtained.

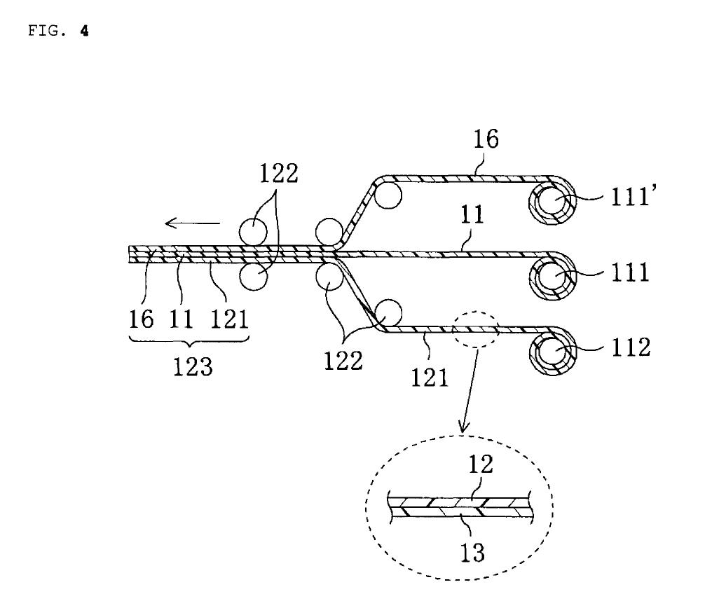

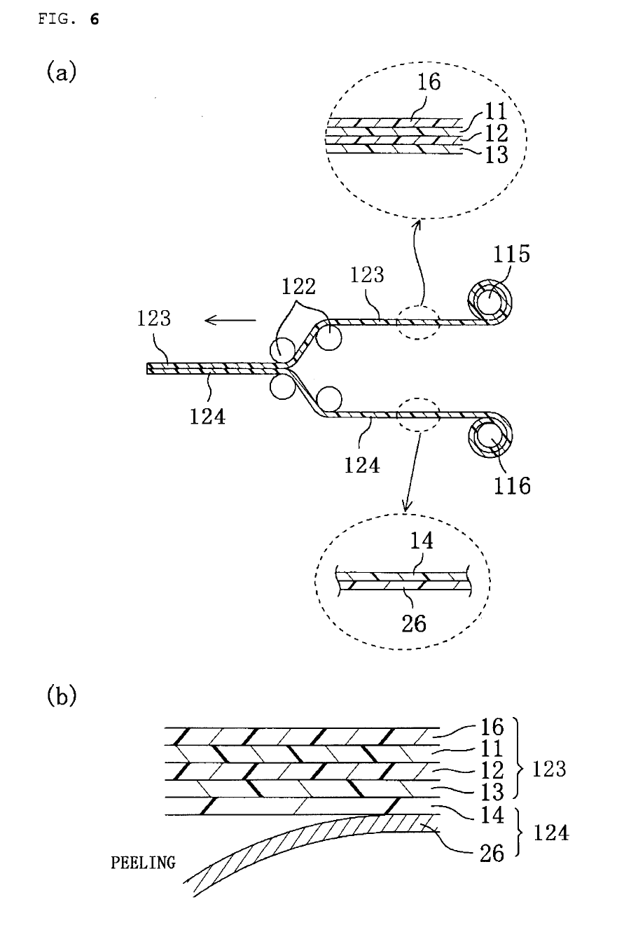

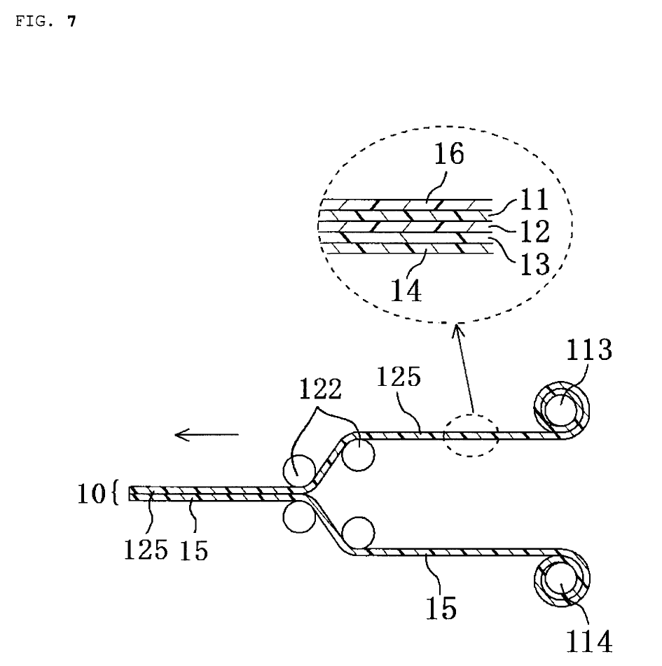

On the other hand, the first birefringent layer 13 is formed on the transparent protective film (that is to be the protective layer) 12, whereby a laminate 121 of the protective layer 12 and the first birefringent layer 13 is obtained. Then, as shown in a schematic view of FIG. 4, the transparent protective film (that is to be the second protective layer) 16, the polarizer 11, and the laminate 121 are sent out in the arrow direction, and attached to each other with an adhesive or the like (not shown) with the respective longitudinal directions aligned. As a result, the laminate 123 (the second protective layer 16, the polarizer 11, the protective layer 12, and the first birefringent layer 13) can be obtained. Note that, in FIG. 4, reference numeral 122 denotes a guide roll for attaching the films to each other (which also applies to FIGS. 6 and 7).

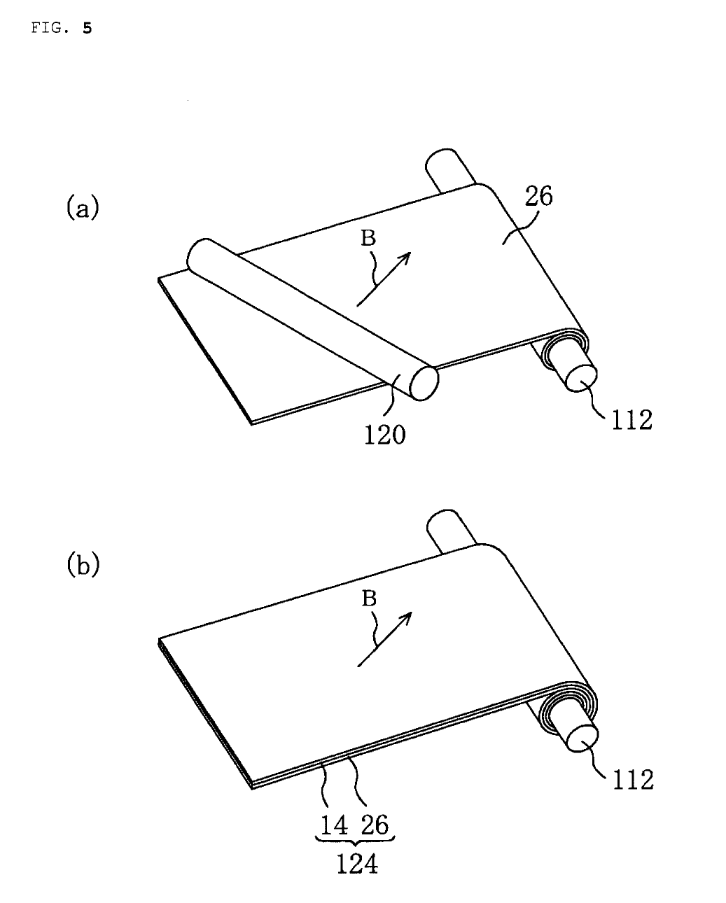

Meanwhile, as shown in a perspective view of FIG. 5(a), a long substrate 26 is prepared, and one surface thereof is subjected to rubbing treatment with a rubbing roll 120. In this case, a direction of the rubbing is set in a direction having a predetermined angle with respect to a lengthwise direction of the substrate 26, a direction of in the range of +8° to +38° or −8° to −38°, for example. Next, as shown in a perspective view of FIG. 5(b), on the substrate 26 subjected to the rubbing treatment, a second birefringent layer 14 is formed as described in the item B-2, whereby the laminate 124 is obtained. In the second birefringent layer 14, a liquid crystal material is aligned along the rubbing direction, and thus a slow axis direction is set in a direction substantially identical to the rubbing direction of the substrate 26 (direction of arrow B).

Further, as shown in a schematic view of FIG. 6(a), the laminates 124 and 123 are sent out in the arrow direction, and attached to each other with an adhesive or the like (not shown) with the respective longitudinal directions aligned. Finally, the substrate 26 is peeled from the attached laminates as shown in FIG. 6(b). As a result, a laminate 125 (the second protective layer 16, the polarizer 11, the protective layer 12, the first birefringent layer 13, and the second birefringent layer 14) can be obtained. In the illustrated example, after the laminate 123 is formed once, the laminate 124 is attached thereto. However, the second protective layer 16, the polarizer 11, the laminate 121, and the laminate 124 may be attached to each other at a time.

Further, as shown in a schematic view of FIG. 7, the long third birefringent layer 15 is prepared, and the third birefringent layer 15 and the laminate 125 are sent out in the arrow direction, and attached to each other with an adhesive or the like (not shown) with the respective longitudinal directions aligned. As the third birefringent layer, there is a stretched polymer film as described above, and the slow axis thereof can be determined appropriately by a method of stretching treatment (stretching direction, etc.). In the present invention, as described above, the direction of the slow axis of the second birefringent layer can be set freely by the alignment treatment with respect to the substrate 26. Thus, as the third birefringent layer, for example, a general stretched polymer film stretched transversely in a direction perpendicular to a longitudinal direction can be used, and hence the third birefringent layer is easy to treat.

As described above, the elliptically polarizing plate 10 of the present invention is obtained.

### B-6. Other Components of Elliptically Polarizing Plate

The elliptically polarizing plate of the present invention may further include another optical layer. Any appropriate optical layer may be employed as the other optical layer in accordance with the purpose or the type of an image display device. Specific examples of the other optical layer include a birefringent layer (retardation film), a liquid crystal film, a light scattering film, and a diffraction film.

Further, as described above, the elliptically polarizing plate of the present invention can have the second protective layer 16 on the surface of the polarizer 11, on which surface the protective layer 12 is not formed. As such a second protective layer, any suitable protective layer (transparent protective film) can be adopted. For example, the film described in the item A-6 can be used. The second protective layer 16 and the protective layer 12 may the same or different. The second protective layer 16 can be subjected to hard coat treatment, reflection preventing treatment, sticking preventing treatment, antiglare treatment, and the like, if required.

The elliptically polarizing plate of the present invention may further include an pressure-sensitive adhesive layer as an outermost layer on at least one side. Inclusion of the pressure-sensitive adhesive layer as an outermost layer facilitates lamination of the elliptically polarizing plate with other members (such as liquid crystal cell), to thereby prevent peeling off of the elliptically polarizing plate from other members. Any appropriate material may be employed as a material for the pressure-sensitive adhesive layer described above. Specific examples of the adhesive include those described in the item B-4. A material having excellent humidity resistance and thermal resistance is preferably used. This is because the material can prevent foaming or peeling due to moisture absorption, degradation of optical properties and warping of a liquid crystal cell due to difference in thermal expansion, and the like.

For practical purposes, the surface of the pressure-sensitive adhesive layer is covered with any appropriate separator until the elliptically polarizing plate is actually used, to thereby prevent contamination. The separator may be formed on any appropriate film as required by providing a release coating by using a silicone-based, long-chain alkyl-based, fluorine-based, or molybdenum sulfide release agent, for example.

Each layer of the elliptically polarizing plate of the present invention may be provided with UV absorbability through treatment or the like with a UV absorber such as a salicylate-based compound, a benzophenone-based compound, a benzotriazole-based compound, a cyanoacrylate-based compound, or a nickel complex salt-based compound.

### C. Use of Elliptically Polarizing Plate

The elliptically polarizing plate of the present invention may be suitably used for various image display devices (such as liquid crystal display device and self luminous display). Specific examples of the image display device for which the elliptically polarizing plate may be used include a liquid crystal display device, an EL display, a plasma display (PD), and a field emission display (FED). The elliptically polarizing plate of the present invention used for a liquid crystal display device is useful for visible angle compensation, for example. The elliptically polarizing plate of the present invention is used for a liquid crystal display device of a circularly polarization mode, and is particularly useful for a homogeneous alignment TN liquid crystal display device, in-plane switching (IPS) liquid crystal display device, and a vertical alignment (VA) liquid crystal display device. The elliptically polarizing plate of the present invention used for an EL display is useful for prevention of electrode reflection.

### D. Image Display Device

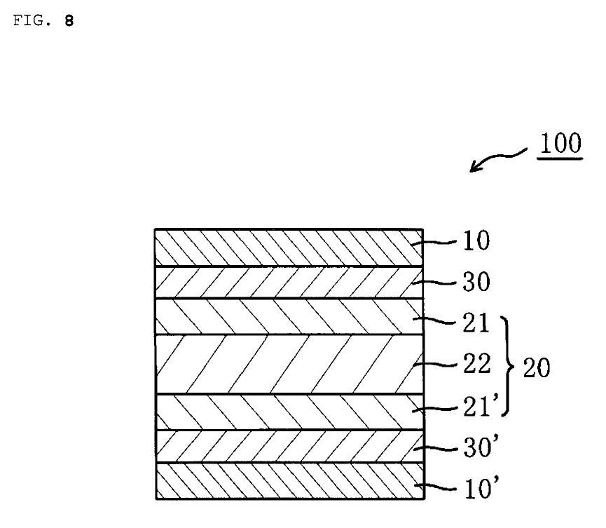

A liquid crystal display device will be described as an example of the image display device of the present invention. Here, a liquid crystal panel used for the liquid crystal display device will be described. Any appropriate constitution may be employed for the constitution of the liquid crystal display device excluding the liquid crystal panel in accordance with the purpose. FIG. 8 is a schematic cross-sectional view of a liquid crystal panel according to a preferred embodiment of the present invention. A liquid crystal panel 100 includes: a liquid crystal cell 20, retardation plates 30 and 30′ arranged on both sides of the liquid crystal cell 20; and polarizing plates 10 and 10′ arranged on outer sides of the respective retardation plates. Any appropriate retardation plates may be employed as the retardation plates 30 and 30′ in accordance with the purpose and an alignment mode of the liquid crystal cell. At least one of or both of the retardation plates 30 and 30′ may be omitted in accordance with the purpose and the alignment mode of the liquid crystal cell. The polarizing plate 10 is the elliptically polarizing plate of the present invention as described in the items A and B. The polarizing plate 10′ is any appropriate polarizing plate. The polarizing plates 10 and 10′ are typically arranged such that absorption axes of the respective polarizers are perpendicular to each other. As shown in FIG. 8, the elliptically polarizing plate 10 of the present invention is preferably arranged on a visual side (upper side) in the liquid crystal display device (liquid crystal panel) of the present invention. The liquid crystal cell 20 includes: a pair of glass substrates 21 and 21′; and a liquid crystal layer 22 as a display medium arranged between the substrates. One substrate (active matrix substrate) 21′ is provided with: a switching element (TFT, in general) for controlling electrooptic properties of liquid crystal; and a scanning line for providing a gate signal to the switching element and a signal line for providing a source signal thereto (the element and the lines not shown). The other glass substrate (color filter substrate) 21 is provided with color filters (not shown). The color filters may be provided in the active matrix substrate 21′ as well. A space (cell gap) between the substrates 21 and 21′ is controlled by a spacer (not shown). An aligned film (not shown) formed of, for example, polyimide is provided on a side of each of the substrates 21 and 21′ in contact with the liquid crystal layer 22.

Hereinafter, the present invention will be more specifically described by way of examples. However, the present invention is not limited to the examples. Methods of measuring properties in the examples are as described below.

### (1) Measurement of Retardation

Refractive indices nx, ny, and nz of a sample film were measured with an automatic birefringence analyzer (Automatic birefringence analyzer KOBRA-31PR manufactured by Oji Scientific Instruments), and an in-plane retardation Δnd a thickness direction retardation Rth were calculated. A measurement temperature was 23° C., and a measurement wavelength was 590 nm.

### (2) Measurement of Thickness

The thickness of each of the first and second birefringent layers was measured through interference thickness measurement by using MCPD-2000, manufactured by Otsuka Electronics Co., Ltd. The thickness of each of other various films was measured with a dial gauge.

### (3) Measurement of a Transmittance

The elliptically polarizing plate obtained in the example was attached to another elliptically polarizing plate obtained in the example with an adhesive. At this time, the elliptically polarizing plates were attached to each other so that the respective third birefringent layers faced to each other. For attachment, the elliptically polarizing plates were placed so that the slow axes of the third birefringent layers (i.e., λ/4 plates) formed an angle of 90° (consequently, and hence the absorption axes of the polarizers formed an angle of 90°). The transmittance of the attached sample was measured by DOT-3 (trade name) manufactured by Murakami Color Research Laboratory Co., Ltd.

### (4) Measurement of Contrast Ratio

The same elliptically polarizing plates were superimposed, and were irradiated with backlight. A white image (absorption axes of polarizers are in parallel with each other) and a black image (absorption axes of polarizers are perpendicular to each other) were displayed, and were scanned from 45° to −135° with respect to the absorption axis of the polarizer on the visual side, and from −60° to 60° with respect to the normal by using “EZ Contrast 160D” (trade name, manufactured by ELDIM SA). A contrast ratio “YW/YB” in an oblique direction was calculated from a Y value (YW) of the white image and a Y value (YB) of the black image.

### (5) Durability Test

The obtained elliptically polarizing plate was allowed to stand under the conditions of 60° C. and 95% (RH) for 500 hours, and thereafter, the outer appearance was observed visually. The case where the elliptically polarizing plate was transparent was evaluated as “Satisfactory”, and the case where the elliptically polarizing plate was opaque was evaluated as “Normal”.

### Example 1

### I. Production of an Elliptically Polarizing Plate

I-a. Production of a First Birefringent Layer

Twenty parts by weight of a side-chain type liquid crystal polymer represented by the following Chemical Formula (Numeric FIGS. 65 and 35 in the formula represent mol % of a monomer unit, and the polymer is represented as a block polymer body for convenience: weight average molecular weight 5000), 80 parts by weight of polymerizable liquid crystal (Paliocolor LC242 (trade name) manufactured by BASFAktiengesellschaft) exhibiting a nematic liquid crystal phase, and 5 parts by weight of a photopolymerization initiator (Irgacure 907 (trade name) manufactured by Ciba Specialty Chemicals Inc.) were dissolved in 400 parts by weight of cyclopentanone to prepare a liquid crystal coating solution. Then, the coating solution was applied to a TAC film (thickness: 40 μm, which is to be a protective layer, manufactured by Fuji Photo Film Co., Ltd.) with a bar coater, and thereafter, dried by heating at 90° C. for 2 minutes, whereby the liquid crystal was aligned. The liquid crystal layer was irradiated with UV-rays to be cured, whereby a laminate of a protective layer/first birefringent layer was obtained. The in-plane retardation of the first birefringent layer was substantially zero, the thickness direction retardation thereof was −68 nm, and the thickness thereof was 0.7 μm. The thickness direction retardation of the protective layer was 59 nm.

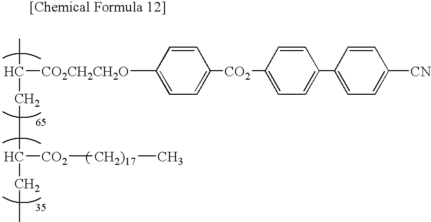

I-b. Production of a Second Birefringent Layer

### I-b-1. Alignment Treatment of a Substrate

A TAC film (thickness: 40 μm) was rubbed with rubbing cloth to produce an alignment substrate. The rubbing treatment was performed at an angle of −23° with respect to the longitudinal direction of the TAC film (23° in a clockwise direction based on the longitudinal direction). The conditions of the alignment treatment were as follows: the rubbing number (number of rubbing rolls) was 1; the radius r of the rubbing roll was 76.89 mm, the rubbing roll rotation number nr was 1500 rpm, the film transportation speed v was 83 mm/sec., and the rubbing strength RS and the push-in amount M were one of the 5 kinds of conditions (a) to (e) as shown in Table 1.

TABLE 1

| | Rubbing strength RS | Push-in amount M |
|---|---|---|
| | (mm) | (mm) |
| Condition (a) | 2618 | 0.3 |
| Condition (b) | 3491 | 0.4 |
| Condition (c) | 4363 | 0.5 |
| Condition (d) | 1745 | 0.2 |
| Condition (e) | 873 | 0.1 |

### I-b-2. Production of a Second Birefringent Layer

First, 10 g of a polymerizable liquid crystal (Paliocolor LC242 (Trade name) manufactured by BASF Aktiengesellschaft) exhibiting a nematic liquid crystal phase and 3 g of a photopolymerization initiator (Irgacure 907 (Trade name) manufactured by Ciba Specialty Chemicals Inc.) for the polymerizable liquid crystal compound were dissolved in 40 g of toluene to prepare a liquid crystal coating solution. Then, the liquid crystal coating solution was applied to the alignment substrate thus produced with a bar coater, and thereafter, dried by heating at 90° C. for 2 minutes, whereby the liquid crystal was aligned. The alignment state of the liquid crystal under the conditions (a) to (c) were very satisfactory. Under the conditions (d) and (e), the alignment of the liquid crystal was disturbed slightly; however, the disturbance was at such a degree as not to cause a problem practically. The liquid crystal layer was irradiated with light of 1 mJ/cm² using a metal halide lamp, and the liquid crystal layer was cured, whereby a second birefringent layer was formed on the substrate. The thickness of the second birefringent layer was 2.4 μm, and the in-plane retardation was 240 nm.

I-c. Production of a Third Birefringent Layer

A norbornene-based film (thickness: 60 μm, ZEONOR (Trade name) manufactured by Zeon Corporation) was uniaxially stretched laterally by 1.5 times at 138° C. to obtain a third birefringent layer with a thickness of 39 μm. The birefringent layer has a refractive index profile of nx>ny>nz, and the in-plane retardation thereof was 120 μm and the Nz coefficient thereof was 1.6.

I-d. Production of an Elliptically Polarizing Plate

A polyvinyl alcohol film was dyed in an aqueous solution containing iodine, and uniaxially stretched by 6 times between rolls having different speeds in an aqueous solution containing boric acid to obtain a polarizer. The polarizer, a TAC film (thickness: 40 μm, which is to be a second protective layer), and the laminate of the protective layer/first birefringent layer, the second birefringent layer and the third birefringent layer obtained as described above were laminated in the production procedure shown in FIGS. 3 to 7, whereby an elliptically polarizing plate A (second protective layer/polarizer/protective layer/first birefringent layer/second birefringent layer/third birefringent layer) as shown in FIG. 1 was obtained. Rth₁/Rthp in the elliptically polarizing plate A was 1.1.

I-e. Evaluation of Elliptically Polarizing Plate

The elliptically polarizing plates A were layered and measured for a contrast ratio. Consequently, the angles at which a contrast of 10 or more was obtained were 400 at minimum and 80° at maximum in an entire azimuth. Further, the angles at which a contrast of 20 or more was obtained were 37° at minimum and 80° at maximum in an entire azimuth. Such a contrast was at a practically preferred level as a mobile display to be viewed by a number of people. Further, moisture resistance of the elliptically polarizing plate A was satisfactory.

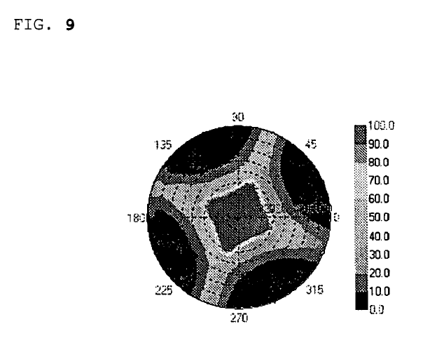

On the other hand, a liquid crystal panel was taken out from a liquid crystal display device (Play Station Portable (Trade name) manufactured by SONY Corporation), and optical films such as polarizing plates placed on upper and lower sides of a liquid crystal cell were removed completely. The surfaces of both glass substrates of the obtained liquid crystal cell were washed to obtain a liquid crystal cell. The elliptically polarizing plates A were attached to both sides of the liquid crystal cell with an acrylic pressure-sensitive adhesive. At this time, the elliptically polarizing plates A were attached to both sides of the liquid crystal cell so that the third birefringent layers were placed on the liquid crystal cell side. The elliptically polarizing plates A were also attached to both sides of the liquid crystal cell so that absorption axes of polarizers on the viewer side were perpendicular to the longitudinal direction of the liquid crystal cell. The absorption axes of the polarizers of the respective elliptically polarizing plates A were placed so as to be perpendicular to each other. The liquid crystal panel thus obtained was bonded to a backlight unit of the Play Station Portable to produce a liquid crystal display device. FIG. 9 shows a contour drawing of contrasts of the liquid crystal display device.

### Comparative Example 1

Elliptically polarizing plates B having the same configuration as that of the elliptically polarizing plates A except that the first birefringent layer was not formed were attached to each other, and measured for a contrast ratio. Consequently, the angles at which a contrast of 10 or more was obtained were 40° at minimum and 80° at maximum in an entire azimuth. However, the angles at which a contrast of 20 or more was obtained were 32° at minimum and 590 at maximum in an entire azimuth. Thus, it was confirmed that the viewing angle became small abruptly. The moisture resistance of the elliptically polarizing plate B was satisfactory.

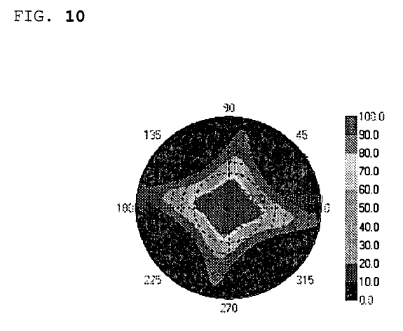

Further, a liquid crystal display device was produced in the same way as in Example 1 except for using the elliptically polarizing plate B. FIG. 10 shows a contour drawing of contrasts of the liquid crystal display device.

### Comparative Example 2

The lamination order of the elliptically polarizing plate A was changed, whereby an elliptically polarizing plate C having the order of (second protective layer/polarizer/protective layer/second birefringent layer/third birefringent layer/first birefringent layer) was obtained. The elliptically polarizing plates C were attached to each other and measured for a contrast ratio. Consequently, the angles at which a contrast of 10 or more was obtained were 30° at minimum and 40° at maximum in an entire azimuth. However, the angles at which a contrast of 20 or more was obtained were 26° at minimum and 33° at maximum in an entire azimuth. Such a contrast was constant even viewed from any azimuth and had less abnormal feeling. However, the angle at which a contrast of 20 or more was obtained was very small, i.e., 33° at maximum; that is, a viewing angle was small, and hence the elliptically polarizing plate C was not preferred practically. The moisture resistance of the elliptically polarizing plate C was satisfactory.

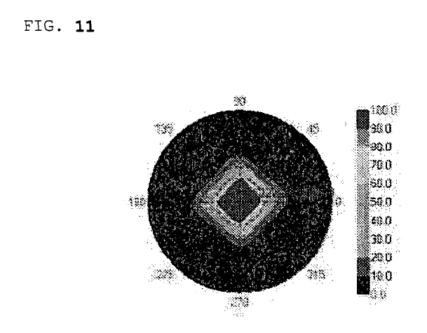

Further, a liquid crystal display device was produced in the same way as in Example 1 except for using the elliptically polarizing plate C. FIG. 11 shows a contour drawing of contrasts of the liquid crystal display device.

### Comparative Example 3

The lamination order of the elliptically polarizing plate A was changed, whereby an elliptically polarizing plate D having the order of (second protective layer/polarizer/protective layer/second birefringent layer/first birefringent layer/third birefringent layer) was obtained. The elliptically polarizing plates D were attached to each other and measured for a contrast ratio. Consequently, the angles at which a contrast of 10 or more was obtained were 37° at minimum and 40° at maximum in an entire azimuth. However, the angles at which a contrast of 20 or more was obtained were 30° at minimum and 40° at maximum in an entire azimuth. Such a contrast was constant even viewed from any azimuth and had less abnormal feeling. However, the angle at which a contrast of 20 or more was obtained was very small, i.e., 40° at maximum; that is, a viewing angle was small, and hence the elliptically polarizing plate D was not preferred practically. The moisture resistance of the elliptically polarizing plate D was satisfactory.

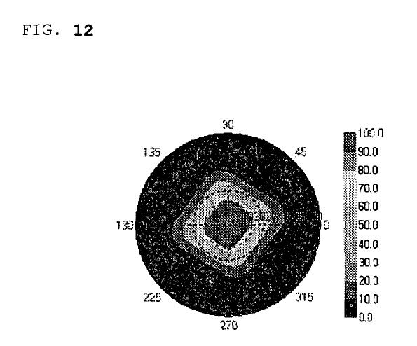

Further, a liquid crystal display device was produced in the same way as in Example 1 except for using the elliptically polarizing plate D. FIG. 12 shows a contour drawing of contrasts of the liquid crystal display device.

As is apparent from the results of the examples and comparative examples, according to the examples of the present invention, by placing the first birefringent layer (positive C plate) adjacent to the protective layer, the angle at which a contrast of 20 or more was obtained was set to be 80° at maximum, and hence a practically preferred level as a mobile display to be viewed by a number of people was ensured. On the other hand, according to any of the comparative examples, the maximum angle at which a contrast of 20 or more was obtained decreased abruptly, and hence a practically preferred level was not ensured. The effects of the examples of the present invention become remarkable by comparing FIG. 9 with FIGS. 10 to 12.

### INDUSTRIAL APPLICABILITY

The elliptically polarizing plate of the present invention may suitably be used for various image display devices (such as a liquid crystal display device and a self-luminous display apparatus).

1. An elliptically polarizing plate, comprising in order: a polarizer; a protective layer; a first birefringent layer having a refractive index profile of nz>nx=ny; a second birefringent layer that functions as a λ/2 plate; and a third birefringent layer that functions as a λ/4 plate.

2. An elliptically polarizing plate according to claim 1, wherein a ratio Rth₁/Rthp between an absolute value Rthp of a thickness direction retardation of the protective layer and an absolute value Rth₁ of a thickness direction retardation of the first birefringent layer is in a range of 1.1 to 4.

3. An elliptically polarizing plate according to claim 1 or 2, wherein an absorption axis of the polarizer and a slow axis of the third birefringent layer are substantially perpendicular to each other.

4. An elliptically polarizing plate according to claim 1, wherein a slow axis of the second birefringent layer defines an angle of +8° to +38° or −8° to −38° with respect to the absorption axis of the polarizer.

5. An elliptically polarizing plate according to claim 1, wherein the protective layer is formed of a film containing triacetyl cellulose as a main component.

6. An image display device comprising the elliptically polarizing plate according to claim 1.

7. An image display device according to claim 6, wherein the elliptically polarizing plate is placed on a viewer side.
